(19) United States
(12) Patent Application Publication
(10) Pub. No.: US 2025/0104257 A1
(43) Pub. Date: Mar. 27, 2025

(54) IMAGE REGISTRATION METHODS AND SYSTEMS

(71) Applicant: TECHINSIGHTS INC., Ottawa (CA)

(72) Inventors: Christopher Pawlowicz, Ottawa (CA); Michael Green, Nepean (CA); Bruno Machado Trindade, Kanata (CA); Hamed Bagheri, Ottawa (CA); Nabil David Bassim, Hamilton (CA); Nasim Khoonkari, Hamilton (CA); Christopher Kumar Anand, Dundas (CA)

(21) Appl. No.: 18/730,253

(22) PCT Filed: Jan. 23, 2023
(86) PCT No.: PCT/CA2023/050073

§ 371 Date: Jul. 18, 2024

(30) Foreign Application Priority Data
Jan. 24, 2022 (CA) 3146594

(51) Int. Cl. G06T 7/32

(52) U.S. Cl. CPC G06T 7/32; G06T 2207/10061; G06T 2207/20068; G06T 2207/30148

(57) ABSTRACT

Described are various embodiments of image registration methods and systems, as well as associated non-transitory computer readable mediums comprising instructions directed to image registration.

### RELATED APPLICATION

The instant application is related to and claims the benefit of priority to Canadian Patent application serial number 3,146,594, entitled “IMAGE REGISTRATION METHODS AND SYSTEMS”, and filed Jan. 24, 2022, the contents of which are hereby fully incorporated by reference.

### FIELD OF THE DISCLOSURE

The present disclosure relates to image registration, and, in particular, to a method for registering at least two images, a digital image registrations system, and a non-transitory computer-readable medium storing related executable instructions.

### BACKGROUND

The accuracy of image capturing is dependent on various factors, including the stability of the image capturing device and/or the subject being captured. Image stabilisation techniques attempt to compensate by, for example, stabilising the mechanics of the image capturing device or otherwise, executing processing algorithms to alter the true captured image prior to display.

Despite the various image stabilisation technologies available, modern image capturing devices remain susceptible to minute movements, especially where high-resolution images are captured, such as those used in microscopy. The distortion, noise, blurring, stretching or other defects which inevitably exhibit in high resolution images detract from the quality thereof, such that down-stream processing becomes challenging. This is particularly so, for example, where high resolution images are to be registered and the distortion, noise, blurring, stretching or other defects present obstacles to accurate registration or otherwise, increase processing power required for registration.

Accurate registration, in turn, is particularly desirable where data is to be extracted from registered images. Such data may relate, for example, to a composition of the subject of the images.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for image registration methods and systems that overcome some of the drawbacks of known techniques, or at least, provides a useful alternative thereto. Some aspects of this disclosure provide examples of such a method for registering at least two images, a digital image registration system and a non-transitory computer-readable medium storing related executable instructions.

In accordance with one aspect, there is provided a method for registering at least two images, each corresponding at least in part to a common region of interest, the method comprising, for each of the at least two images, calculating respective image reductions along a first axis, determining a similarity profile between the respective image reductions in accordance with a similarity function, and identifying a first profile feature in the similarity profile to inform an image transformation for registering the at least two images.

In one embodiment, the method may further comprise, for each of the at least two images, calculating respective second image reductions along a second axis, determining a second similarity profile between the second image reductions in accordance with the similarity function, and identifying a second profile feature in the second similarity profile to further inform the image transformation.

In one embodiment, the at least two images may be sub-images of respective larger images of the common region of interest. In one embodiment, the method may further comprise defining the at least two images from the respective larger images.

In one embodiment, the at least two images may be elements of a mosaic of at least partially overlapping images. In one embodiment, the at least two images may be elements of respective adjacent edge portions of at least partially overlapping images.

In one embodiment, the respective image reductions may comprise a plurality of numeric values. In one embodiment, the respective image reductions may comprise a plurality of pixel intensity values. In one embodiment, the image reductions may comprise one or more of a summation, a maximum intensity projection, an integration, an average, a weighted mean, a median, or a flattening of pixel intensities for a line of pixels in the at least two images respectively.

In one embodiment, the at least two images may comprise images of differing dimensions.

In one embodiment, the similarity function may comprise one or more of a correlation function, a convolution function, a sum-of-squared difference function, a Fourier transformation, or a bivariate correlation function. In one embodiment, the similarity function comprises a normalisation. In one embodiment, the similarity function may comprise a self-correlation function. In one embodiment, the similarity function may comprise a cross-correlation function. In one embodiment, the similarity function may comprise a normalised cross-correlation. In one embodiment, the similarity function may comprise one or more of a linear transformation, a non-linear transformation, a shift, a stretch, a skew, or a rotation, of one or more of the at least two images.

In one embodiment, determining the similarity profile may comprise detecting any one or both of an image distortion or a scale difference between the at least two images.

In one embodiment, the first profile feature may comprise one or more extrema.

In one embodiment, the method may further comprise determining a self-similarity profile for a first of the respective image reductions in accordance with a self-similarity function, and identifying a self-similarity profile feature in the self-similarity profile corresponding to a designated degree of similarity.

In one embodiment, the image transformation may correspond to one or more of a linear transformation, a non-linear transformation, a shift, a stretch, a skew, or a rotation, of one or more of the at least two images at least in part. In one embodiment, the image transformation may comprise a transformation of at least one of the at least two images into another of the at least two images as a local image transformation. In one embodiment, the image transformation may comprise a transformation of at least one of the at least two images into a global reference frame.

In one embodiment, the method may further comprise applying the image transformation to at least one of the two or more images.

In one embodiment, the image transformation may comprise a pixel transformation of each pixel of one or more of the at least two images.

In one embodiment, the at least two images comprise images of an integrated circuit layer.

In one embodiment, the method may be implemented by at least one processor in communication with a non-transitory computer readable medium, the non-transitory computer readable medium storing executable instructions, and an image storage database, the image storage database including at least the at least two images.

In one embodiment, the method may be operable as an intensity-based image registration method. In one embodiment, the method may be operable in combination with a feature-based image registration method.

In one embodiment, the at least two images may comprise at least partially periodic features or patterns.

+

In accordance with another aspect, there is provided a digital image registration system operable to register at least two images, the at least two images each corresponding at least in part to a common region of interest, the system comprising, a memory on which the at least two images are stored in an image storage database, and a digital data processor operatively connected to the memory to retrieve the at least two images from the image storage database, and operable to: calculate respective image reductions for each of the at least two images along a first axis and optionally, along a second axis, determine a similarity profile between the respective image reductions in accordance with a similarity function, and identify a profile feature in the similarity profile to inform an image transformation for registering the at least two images.

In one embodiment, the at least two images are sub-images of respective larger images which, together with other larger images, may comprise a mosaic of at least partially overlapping images. In one embodiment, the at least two images may comprise respective adjacent edge portions of at least partially overlapping larger images.

In one embodiment, the respective image reductions may comprise intensity-based image reductions. In one embodiment, the respective image reductions may comprise one or more of: a summation, a maximum intensity projection, an integration, an average, a weighted mean, a median, or a flattening, of pixel intensities for a line of pixels in the at least two images respectively.

In one embodiment, the similarity function may comprise one or more of: a correlation function, a convolution function, a sum-of-squared difference function, a Fourier transformation, or a bivariate correlation function. In one embodiment, the similarity function may comprise any one or both of: a self-correlation function and a cross-correlation function. In one embodiment, the similarity function may comprise a normalised cross-correlation. In one embodiment, the similarity function may comprise one or more of: a linear transformation, a non-linear transformation, a shift, a stretch, a skew, or a rotation, of one or more of the at least two images.

In one embodiment, determining the similarity profile may comprise detecting any one or both of: an image distortion, or a scale difference, between the at least two images.

In one embodiment, the profile feature may comprise one or more extrema.

In one embodiment, the image transformation may correspond to one or more of: a linear transformation, a non-linear transformation, a shift, a stretch, a skew, or a rotation, of one or more of the at least two images, at least in part.

In one embodiment, the image transformation may comprise a transformation of at least one of the at least two images into another of the at least two images as a local image transformation. In one embodiment, the image transformation may comprise a transformation of at least one of the at least two images into a global reference frame. In one embodiment, the image transformation may comprise a pixel transformation of each pixel of one or more of the at least two images.

In one embodiment, the digital data processor may be further operable to execute the image transformation and store a registered image on the image storage database.

In one embodiment, the at least two images comprise images of an integrated circuit layer.

In accordance with yet a further aspect, there is provided a non-transitory computer-readable medium storing executable instructions which, when executed by a digital data processor, are operable to: retrieve at least two images, each corresponding at least in part to a common region of interest, from an image storage database, calculate, via a digital data processor, respective image reductions for each of the at least two images along a first axis and optionally, along a second axis, determine, via the digital data processor, a similarity profile between the respective image reductions in accordance with a similarity function, and identify a profile feature in the similarity profile to inform an image transformation for registering the at least two images.

In one embodiment, the at least two images may be sub-images of respective at least partially overlapping larger images of the common region of interest. In one embodiment, the at least two images may be respective adjacent edge portions of at least partially overlapping larger images of the common region of interest.

In one embodiment, the respective image reductions may comprise intensity-based reductions. In one embodiment, the intensity-based reductions may comprise a plurality of pixel intensity values. In one embodiment, the image reductions may comprise one or more of a summation, a maximum intensity projection, an integration, an average, a weighted mean, a median, or a flattening, of pixel intensities for a line of pixels in the at least two images respectively.

In one embodiment, the similarity function may comprise one or more of a correlation function, a convolution function, a sum-of-squared difference function, a Fourier transformation, or a bivariate correlation function. In one embodiment, the similarity function may comprise any one or both of: a self-correlation function and a cross-correlation function. In one embodiment, the similarity function may comprise a normalised cross-correlation. In one embodiment, the similarity function may comprise one or more of a linear transformation, a non-linear transformation, a shift, a stretch, a skew, or a rotation, of one or more of the at least two images.

In one embodiment, determining the similarity profile may comprise detecting any one or both of an image distortion or a scale difference between the at least two images.

In one embodiment, the profile feature may comprise one or more extrema.

In one embodiment, the image transformation may correspond to one or more of a linear transformation, a non-linear transformation, a shift, a stretch, a skew, or a rotation, of one or more of the at least two images at least in part. In one embodiment, the image transformation may comprise a transformation of at least one of the at least two images into another of the at least two images as a local image transformation. In one embodiment, the image transformation may comprise a transformation of at least one of the at least two images into a global reference frame. In one embodiment, the image transformation may comprise a pixel transformation of each pixel of one or more of the at least two images.

In one embodiment, the executable instructions may further comprise instructions to execute the image transformation and store a registered image on the image storage database.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a schematic flow-diagram illustrating an exemplary method for registering at least two images of interest, the at least two images corresponding at least in part to a common region of interest, in accordance with one aspect of the disclosure;

FIG. 2 is a schematic component diagram illustrating an exemplary digital image registration system operable to register at least two images taken with imaging hardware, the at least two images corresponding at least in part to a common region of interest, in accordance with another aspect of the disclosure;

FIG. 3, comprised of FIGS. 3A to 3Q, exemplifies various examples of one embodiment of the method of FIG. 1 in use, wherein:

FIGS. 3A and 3B are (overlapping) images of an exemplary integrated circuit (IC) layer obtained with a scanning electron microscope (SEM),

FIGS. 3C and 3D are two exemplary sub-images of same dimensions defined from the SEM images of FIGS. 3A and 3B, respectively,

FIGS. 3E and 3F are exemplary sub-sub-images defined from the sub-images of FIGS. 3C and 3D, respectively,

FIGS. 3G and 3H are plots representing exemplary image reductions in different axes (or directions) of the sub-sub-images of FIGS. 3E and 3F,

FIGS. 3I and 3J are further exemplary sub-sub-images defined from the sub-images of FIGS. 3C and 3D, respectively,

FIGS. 3K and 3L are plots representing exemplary image reductions in different axes (or directions) of the sub-sub-images of FIGS. 3I and 3J,

FIGS. 3M and 3N are yet further exemplary sub-sub-images defined from the sub-images of FIGS. 3C and 3D, respectively,

FIGS. 3O and 3P are plots representing exemplary image reductions in different axes (or directions) of the sub-sub-images of FIGS. 3M and 3N, and

FIG. 3Q is a plot representing the exemplary image reduction of FIG. 3P but shifted in a lengthwise direction to align the image reductions;

FIG. 4, comprised of FIGS. 4A to 4P, exemplifies various examples of one embodiment of the method of FIG. 1 in use, wherein:

FIG. 4A is a larger image of another exemplary IC layer obtained with a SEM,

FIGS. 4B and 4C are two exemplary sub-images of differing dimensions defined from the SEM image of FIG. 4A,

FIGS. 4D and 4E are plots representing exemplary image reductions of the sub-images of FIGS. 4B and 4C, respectively,

FIG. 4F is a plot representing an exemplary cross-correlation of the image reductions of FIGS. 4D and 4E, thus reflecting a similarity profile of the sub-images of FIGS. 4B and 4C with a first profile feature indicated in broken lines,

FIGS. 4G and 4H are two further exemplary sub-images of differing dimensions defined from the SEM image of FIG. 4A,

FIGS. 4I and 4J are plots representing exemplary image reductions of the sub-images of FIGS. 4G and 4H, respectively,

FIG. 4K is a plot representing an exemplary cross-correlation of the image reductions of FIGS. 4I and 4J, thus reflecting a similarity profile of the sub-images of FIGS. 4G and 4H with a first profile feature indicated in broken lines,

FIGS. 4L and 4M are two yet further exemplary sub-images of differing dimensions defined from the SEM image of FIG. 4A,

FIGS. 4N and 4O are plots representing exemplary image reductions of the sub-images of FIGS. 4L and 4M, respectively,

FIG. 4P is a plot representing an exemplary cross-correlation of the image reductions of FIGS. 4N and 40, thus reflecting a similarity profile of the sub-images of FIGS. 4L and 4M with a first profile feature indicated in broken lines;

FIG. 5, comprised of FIGS. 5A to 5S, exemplifies various examples of one embodiment of the method of FIG. 1 in use, wherein:

FIGS. 5A and 5B are two larger (overlapping) images of another exemplary IC layer obtained with a SEM,

FIGS. 5C and 5D are two exemplary sub-images of different dimensions defined from the SEM images of FIGS. 5A and 5B, respectively,

FIGS. 5E and 5F are exemplary sub-sub-images of differing dimensions defined from the sub-images of FIGS. 5C and 5D, respectively,

FIGS. 5G and 5H are plots representing exemplary image reductions of the sub-sub-images of FIGS. 5E and 5F, respectively,

FIG. 5I is a plot representing an exemplary cross-correlation of the image reductions of FIGS. 5G and 5H, reflecting the similarity profile of the sub-sub-images of FIGS. 5E and 5F with a first profile feature indicated in broken lines,

FIGS. 5J and 5K are further exemplary sub-sub-images of differing dimensions defined from the sub-images of FIGS. 5C and 5D, respectively,

FIGS. 5L and 5M are plots representing exemplary image reductions of the sub-sub-images of FIGS. 5J and 5K,

FIG. 5N is a plot representing an exemplary cross-correlation of the image reductions of FIGS. 5L and 5M, reflecting the similarity profile of the sub-sub-images of FIGS. 5J and 5K with a first profile feature indicated in broken lines,

FIGS. 5O and 5P are yet further exemplary sub-sub-images of differing dimensions defined from the sub-images of FIGS. 5C and 5D, respectively,

FIGS. 5Q and 5R are plots representing exemplary image reductions of the sub-sub-images of FIGS. 5O and 5P, respectively,

FIG. 5S is a plot representing an exemplary cross-correlation of the image reductions of FIGS. 5Q and 5R, reflecting the similarity profile of the sub-sub-images of FIGS. 5O and 5P with a first profile feature indicated in broken lines;

FIG. 6, comprised of FIGS. 6A to 6S, exemplifies various examples of one embodiment of the method of FIG. 1 in use, wherein:

FIGS. 6A and 6B are two (overlapping) images of another exemplary IC layer obtained with a SEM,

FIGS. 6C and 6D are two exemplary sub-images of different dimensions defined from the SEM images of FIGS. 6A and 6B, respectively,

FIGS. 6E and 6F are exemplary sub-sub-images of differing dimensions defined from the sub-images of FIGS. 6C and 6D, respectively,

FIGS. 6G and 6H are plots representing exemplary image reductions of the sub-sub-images of FIGS. 6E and 6F,

FIG. 61 is a plot representing an exemplary cross-correlation of the image reductions of FIGS. 6G and 6H, reflecting the similarity profile of the sub-sub-images of FIGS. 6E and 6F with a first profile feature indicated in broken lines,

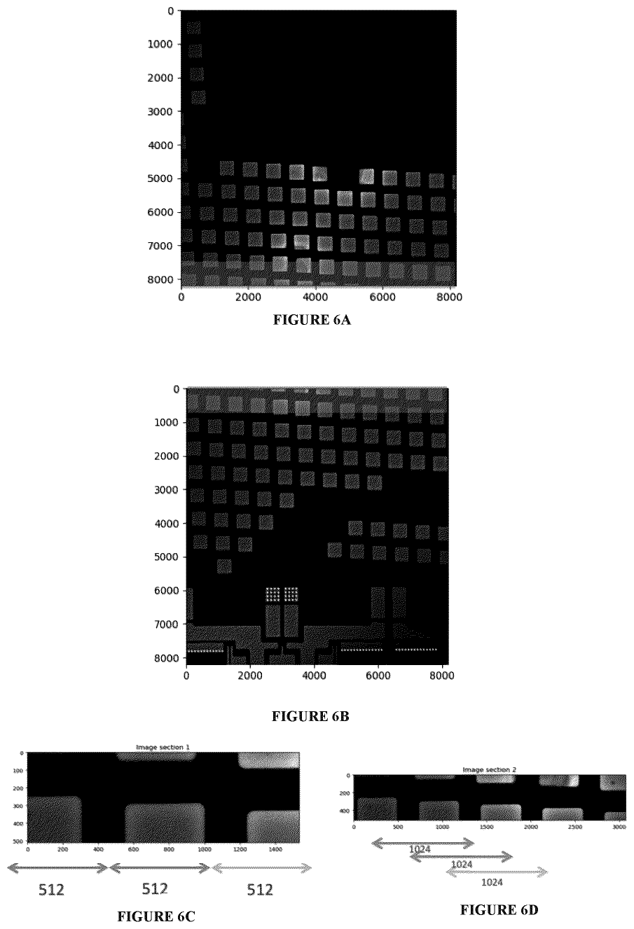

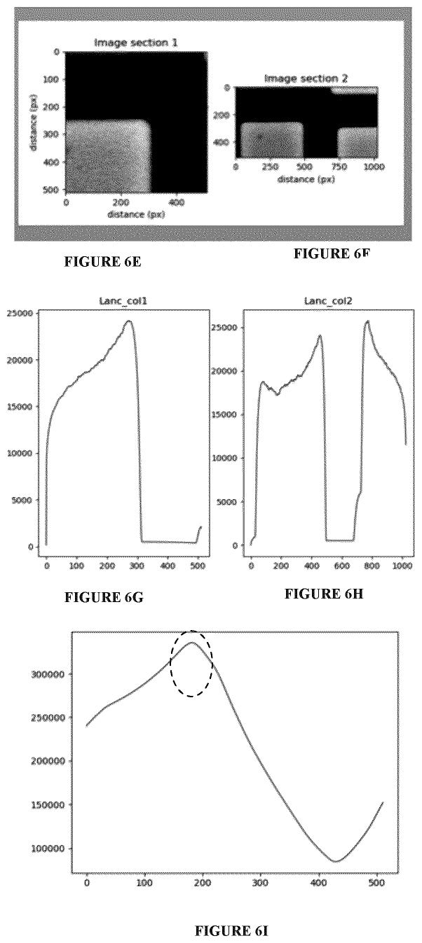

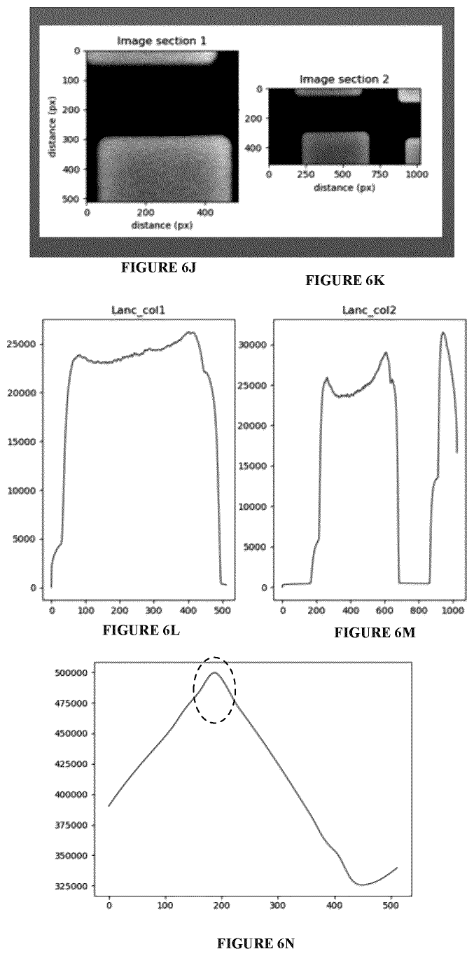

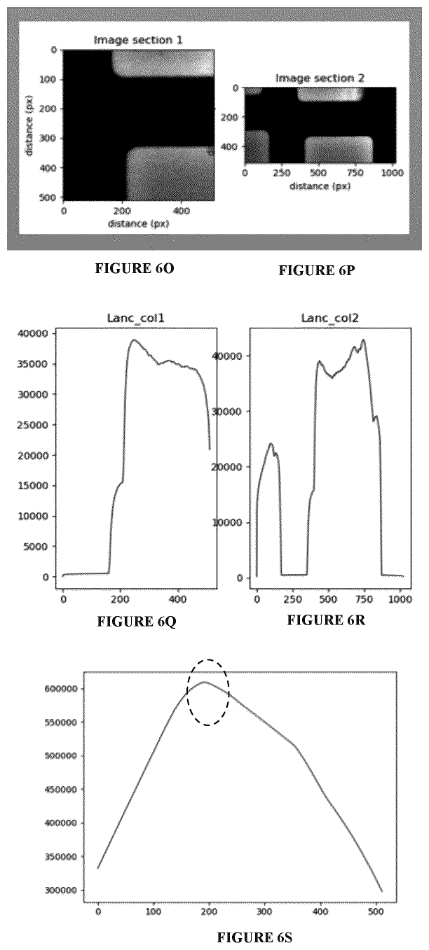

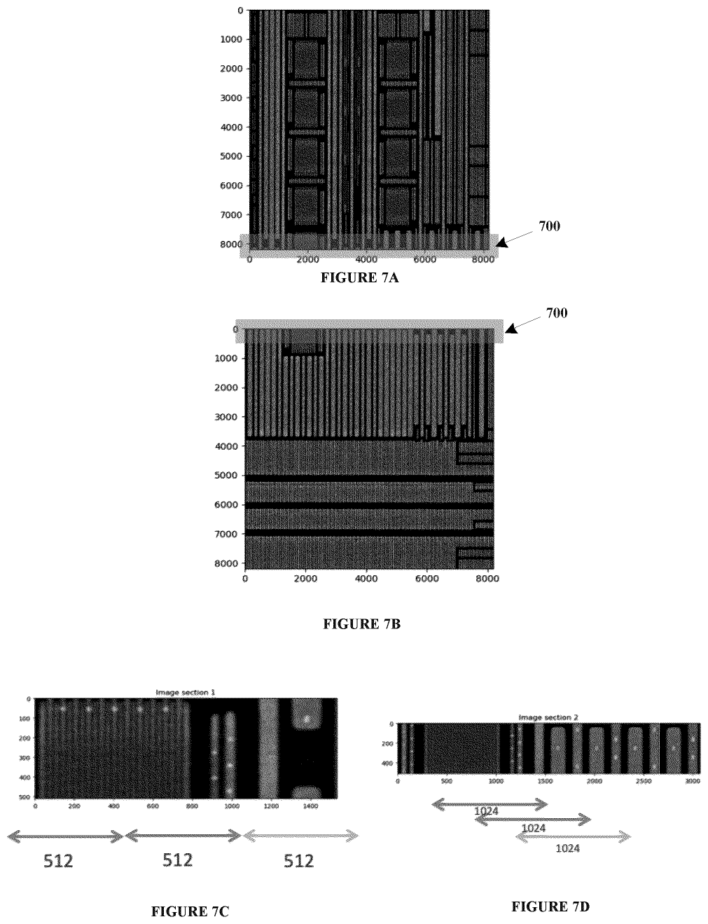

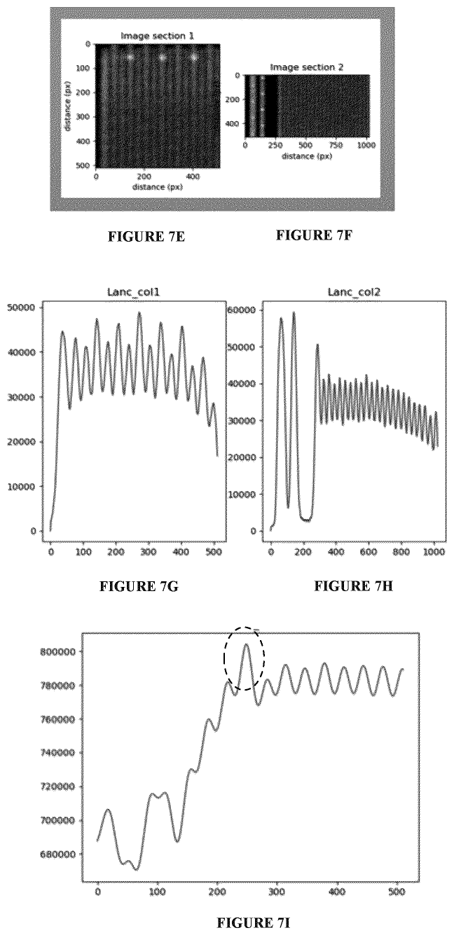

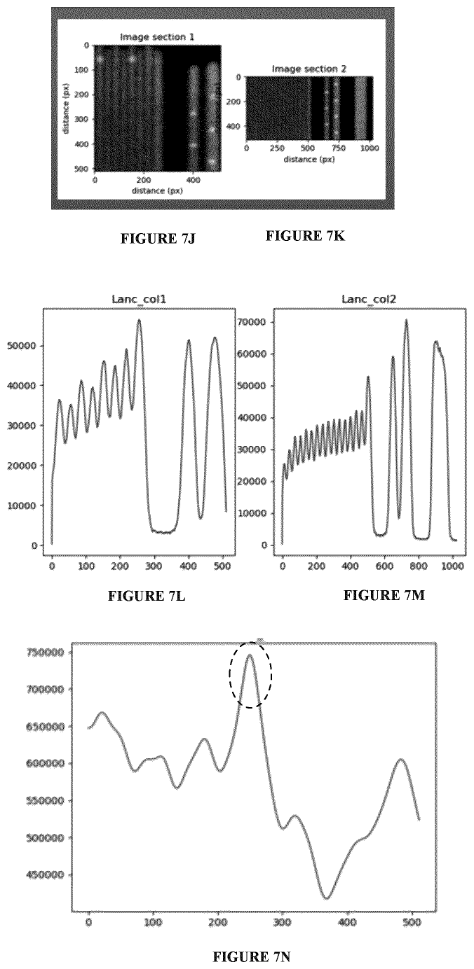

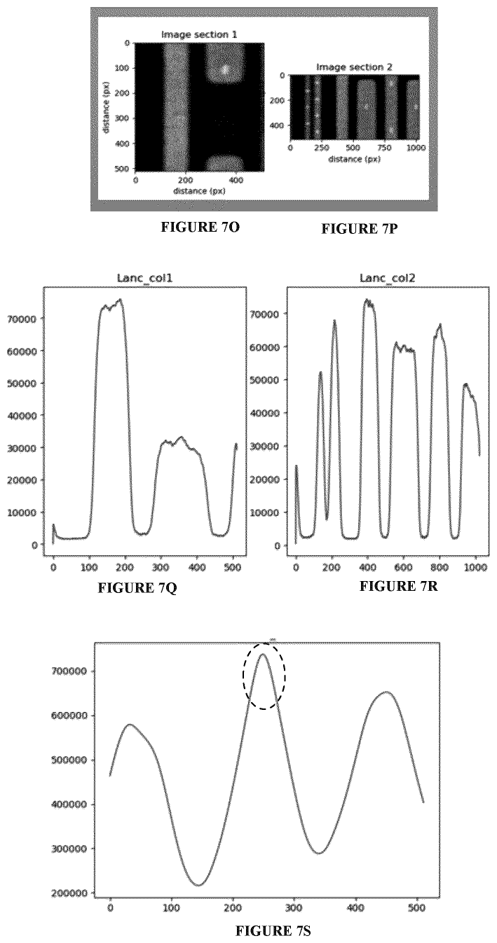

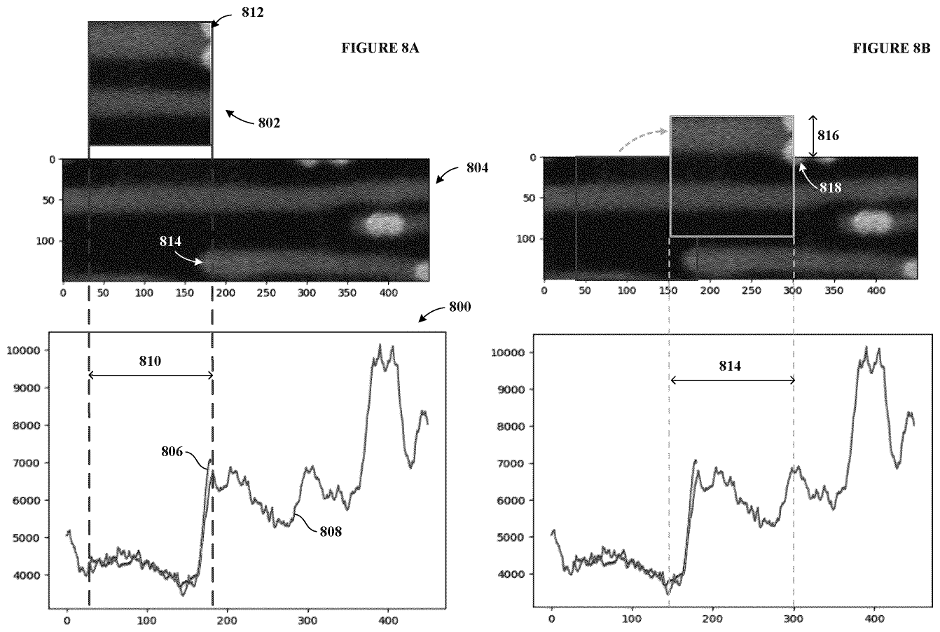

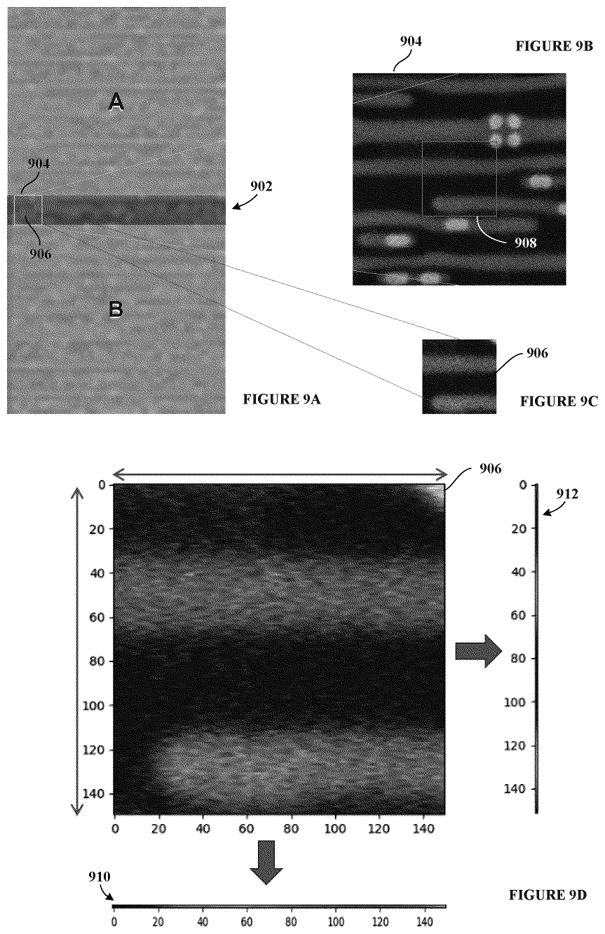

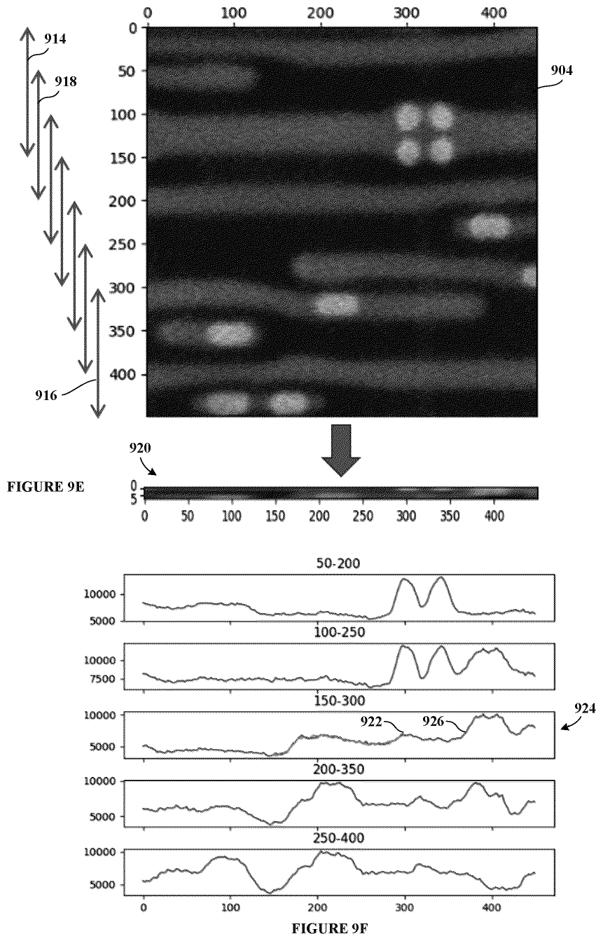

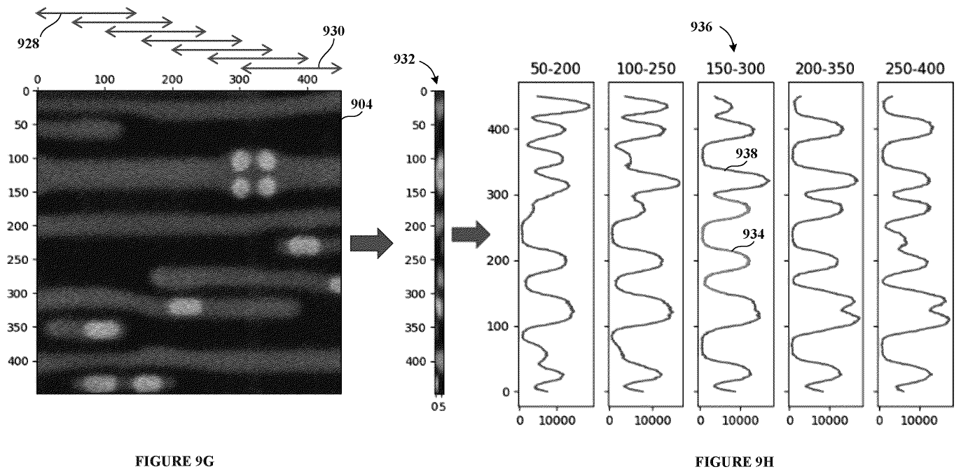

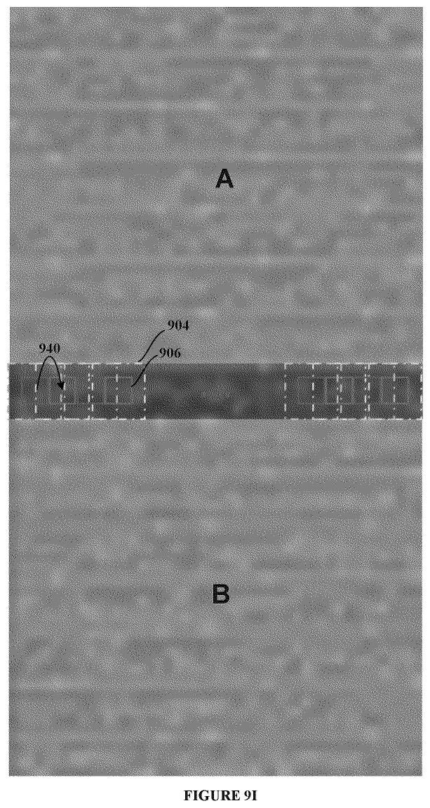

FIGS. 6J and 6K are further exemplary sub-sub-images of differing dimensions defined from the sub-images of FIGS. 6C and 6D, respectively,

FIGS. 6L and 6M are plots representing exemplary image reductions of the sub-sub-images of FIGS. 6J and 6K, respectively,

FIG. 6N is a plot representing an exemplary cross-correlation of the image reductions of FIGS. 6L and 6M, reflecting the similarity profile of the sub-sub-images of FIGS. 6J and 6K with a first profile feature indicated in broken lines,

FIGS. 6O and 6P are yet further exemplary sub-sub-images of differing dimensions defined from the sub-images of FIGS. 6C and 6D, respectively,

FIGS. 6Q and 6R are plots representing exemplary image reductions of the sub-sub-images of FIGS. 6Q and 6R, respectively,

FIG. 6S is a plot representing an exemplary cross-correlation of the image reductions of FIGS. 6Q and 6R, reflecting the similarity profile of the sub-sub-images of FIGS. 6O and 6P with a first profile feature indicated in broken lines; and

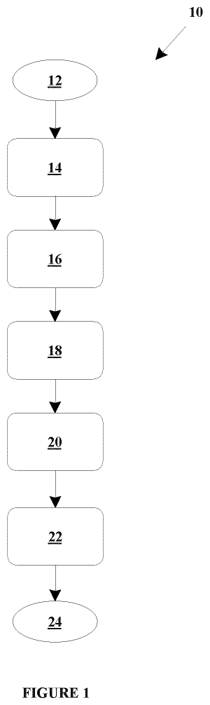

FIG. 7, comprised of FIGS. 7A to 7S, exemplifies various examples of one embodiment of the method of FIG. 1 in use, wherein:

FIGS. 7A and 7B are two (overlapping) images of another exemplary IC layer obtained with a SEM,

FIGS. 7C and 7D are two exemplary sub-images of different dimensions defined from the SEM images of FIGS. 7A and 7B, respectively,

FIGS. 7E and 7F are exemplary sub-sub-images of differing dimensions defined from the sub-images of FIGS. 7C and 7D, respectively,

FIGS. 7G and 7H are plots representing exemplary image reductions of the sub-sub-images of FIGS. 7E and 7F, respectively,

FIG. 7I is a plot representing an exemplary cross-correlation of the image reductions of FIGS. 7G and 7H, reflecting the similarity profile of the sub-sub-images of FIGS. 7E and 7F with a first profile feature indicated in broken lines,

FIGS. 7J and 7K are further exemplary sub-sub-images of differing dimensions defined from the sub-images of FIGS. 7C and 7D, respectively,

FIGS. 7L and 7M are plots representing exemplary image reductions of the sub-sub-images of FIGS. 7J and 7L, respectively,

FIG. 7N is a plot representing an exemplary cross-correlation of the image reductions of FIGS. 7L and 7M, reflecting the similarity profile of the sub-sub-images of FIGS. 7J and 7K with a first profile feature indicated in broken lines,

FIGS. 7O and 7P are yet further exemplary sub-sub-images of differing dimensions defined from the sub-images of FIGS. 7C and 7D, respectively,

FIGS. 7Q and 7R are plots representing exemplary image reductions of the sub-sub-images of FIGS. 7O and 7P, respectively,

FIG. 7S is a plot representing an exemplary cross-correlation of the image reductions of FIGS. 7Q and 7R, reflecting the similarity profile of the sub-sub-images of FIGS. 7O and 7P with a first profile feature indicated in broken lines.

FIGS. 8A and 8B are schematics illustrating the registration of images that are initially poorly aligned in one dimension; and

FIGS. 9A to 9I are schematics illustrating an exemplary process for improving estimations of image alignment to improve image registration, in accordance with various embodiments.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this disclosure belongs.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification and claims, the meaning of “a,” “an,” and “the” include plural references, unless the context clearly dictates otherwise. The meaning of “in” includes “in” and “on.”

The term “comprising” as used herein will be understood to mean that the list following is non-exhaustive and may or may not include any other additional suitable items, for example one or more further feature(s), component(s) and/or element(s) as appropriate.

The systems and methods described herein provide, in accordance with different embodiments, different examples of a method for registering at least two images, a digital image registration system, and a non-transitory computer-readable medium storing related executable instructions.

In FIG. 1, reference numeral 10 refers, generally, to a method for registering at least two images, the at least two images corresponding at least in part to a common region of interest, in accordance with one aspect of the present disclosure. Method 10 starts at reference numeral 12 and comprises at 16, for each of the at least two images, calculating respective image reductions along a first axis, at 18 calculating a similarity profile between the respective image reductions in accordance with a similarity function, and at 20, identifying a first profile feature in the similarity profile to inform an image transformation for registering the at least two images.

Without detracting from the plain and usual meaning understood by those skilled in the art, the term “registering” or “registration” is to be interpreted broadly in this context, referring generally to a process of stitching, aligning, matching, or mapping images geometrically, without limitation. The term can include registration of sub-images (or sub-sub-images) having at least a portion of shared subject matter (i.e. cross-correlating), for example, or in other examples having identical subject matter (i.e. self-correlating). Registration, in this context, is not limited to having a particular reference or fixed image against which a test image is aligned.

In this embodiment, the at least two images comprise two-dimensional (2D) data of an integrated circuit layer of an integrated circuit (IC), and the at least two images comprise scanning electron microscopy (SEM) images of the integrated circuit layer. It is to be appreciated however, as discussed below, that the at least two images may comprise any visual representation of a surface, an object or other subject matter provided in some form of spatial array. Returning to this embodiment, the at least two images each comprise a 2D array of pixels corresponding to transmission data obtained by an image capturing device of the SEM. Thus, the SEM images reflect the location of various features (e.g. transistors) and circuitry of the IC in pixelated form. The SEM images are greyscale images and reflect different brightness levels corresponding to the presence or absence of components on the integrated circuit layer. For example, brighter regions in SEM images may indicate higher electron reflection, in turn indicating the presence of metallic structures or the like on the integrated circuit layer in that region. In contrast, darker regions in SEM images may indicate lesser electron reflection, in turn indicating an absence of metallic structures and/or the presence of more absorptive material (such as that of typical integrated circuit substrates-ceramic, monocrystalline silicon, gallium arsenide, etc.). Other insulators can also cause darker regions in SEM images of the integrated circuit layer, as those skilled in the art will appreciate.

As mentioned, the at least two images each correspond at least in part to a common region of the integrated circuit layer. More particularly, in this embodiment, the at least two images are sub-images of respective larger images of the common region of the integrated circuit layer. In this embodiment, at 14, method 10 further comprises defining the at least two images from the respective larger images. The at least two images are elements of a mosaic of at least partially (spatially) overlapping images of the integrated circuit layer, being elements of respective adjacent edge portions of at least partially overlapping images of the integrated circuit layer. Defining the at least two images from the respective larger images at 14 may comprise, for example, determining suitable coordinates in each respective larger image which corresponds to an area to be transformed. In some embodiments, suitable coordinates may be determined using a sliding defining box, for example, such that subsequently defined sub-images may at least partially overlap. Other means of defining the at least two images are also herein contemplated, and are intended to fall well within the scope of the present disclosure. As will be appreciable from the present disclosure and exemplary embodiments, utilising sub-images and/or sub-sub-images of larger images for method 10, as the case may be, may be useful in obtaining improved resolution and/or less “noise” as compared to utilising the larger images for method 10, thereby improving overall registration (locally and/or globally). Furthermore, utilising sub-images and/or sub-sub-images of larger images for method 10, as the case may be, may be useful in reducing the image data requiring processing. For example, in some embodiments, utilising sub-sub-images of a common region may reduce image data requiring processing to 5% of the image data contained in the respective larger images.

In this embodiment, the at least two images comprise images of differing dimensions. More particularly, the at least two images comprise images of rectangular shape with differing dimensions, providing areas of different dimensions of the common region of the integrated circuit layer. In other embodiments, the at least two images may comprise one square image and one rectangular image. Regardless of specific shape, such differing image dimensions may be advantageous in providing a degree of freedom in calculating the similarity profile with the similarity function. For example, differing dimensions may provide freedom in shifting, stretching or skewing one of the at least two images lengthwise (and/or in another direction) with reference to the other to calculate a similarity profile at 18 and identify the first profile feature at 20, which in turn, reflects the slide, shift or stretch necessary to find the maximum correlation (reflected in the first profile feature).

As indicated, method 10 comprises, for each of the at least two images, calculating (or reducing) respective image reductions (or projections) along a first axis (or direction) at 16. The image reductions may comprise one or more of a summation, a maximum intensity projection, an integration, an average, a weighted mean, a median, a flattening, and/or another property or representation of pixel intensities for a line, lines, or an area of pixels in the at least two images respectively. In this particular embodiment, the image reductions comprise summation of pixel intensities for each horizontal line of pixels in the at least two images respectively. The pixel intensities are thus summed in the first axis, which, in this embodiment, is the horizontal axis. Thus, the respective image reductions comprise a plurality of numeric values which relate to a plurality of pixel intensity values obtained for the horizontal axis. The respective image reductions of each image therefore reduce each image, in this embodiment, to arrays of summed pixel values for each row of pixels in each image. These are linear, or one-dimensional arrays which, may reduce processing power required to determine the similarity profile at 18 and determine the first profile feature at 20, for example, or otherwise to inform the image transformation of one or both of the at least two images. In some embodiments, calculating (or reducing) respective image reductions (or projections) may average down the noise in the image(s) by a factor of

$$\frac{1}{\sqrt{( number of pixels combined )}}$$

(i.e. 1/sqrt (number pixels combined)), whilst still preserving the grain pattern of the image(s).

In some embodiments of method 10, where image transformation is not easily ascertainable from the image reductions in the first axis (such as after the remainder of method 10), method 10 may comprise calculating (or reducing) respective second image reductions (or projections) along a second axis (or second direction) for each of the at least two images. In particular, in such embodiments, the second axis may be the vertical axis. Calculating the respective second image reductions for the vertical axis may be akin to calculating the respective image reductions for the horizontal axis. Thus, in this embodiment, the respective second image reductions may comprise summation of pixel intensities for each vertical line of pixels (or a plurality of pixel lines, or pixels corresponding to an area) in the at least two images respectively, such that pixel intensities in the second axis are summed. Thus, the respective second image reductions may also comprise a plurality of numeric values, or, more specifically, a plurality of summed pixel intensity values obtained for the vertical axis. The respective second image reductions of each image therefore reduce each image, in this embodiment, to arrays of summed pixel values for each column of pixels in each image. Therefore, in such embodiments, the image reductions may comprise two linear or one-dimensional arrays of summed pixel intensities for each image.

As indicated, method 10 comprises determining (or calculating) a similarity profile between the respective image reductions in accordance with a similarity function at 18. In this embodiment, the similarity function comprises one or more of a correlation function, a convolution function, a sum-of-squared difference function, a Fourier transformation, a bivariate correlation function (i.e. Pearson's r), or the like. Generally, the similarity function may reflect a similarity, correlation or other relationship identified or determined between the respective image reductions of the at least two images. It will be appreciated that the image reductions may be considered variables, and therefore that the similarity function and/or profile may be represented visually in the form of a graph.

In this particular embodiment, the similarity function comprises a cross-correlation function. The cross-correlation function may represent the correlation or similarity between at least two images of slightly differing subject matter, still corresponding to the common region and being adjacent edge portions which are to be registered. The cross-correlation function may comprise any one or combination of: a linear transformation, a non-linear transformation, a shift, a stretch, a skew, or a rotation, of one or more of the at least two images. A shift may comprise, for example, a lengthwise shift, a crosswise shift, a diagonal shift, or the like, of one image or reduction thereof on another. A stretch may correspond to, for example, a lengthwise stretch of one image to relative to another image. In embodiments where the similarity function comprises a rotation, method 10 may include calculating an angle of rotation and/or a direction of rotation of one image relative to another of the at least two images. Thus, a rotation may comprise, for example, a clockwise or counter-clockwise rotation or partial rotation of a number of degrees. It is to be appreciated that calculating the similarity profile at 18 may also comprise detecting any one or both of an image distortion or a scale difference between the at least two images, and therefore that the similarity function may capture or represent such image distortion or scale difference. Exemplary embodiments of the similarity function are discussed below.

Returning to this particular embodiment, the cross-correlation function relates to a linear transformation in the form of a lengthwise shift of one image to match or align to another image in a horizontal direction. For example, respective image reductions along a first axis (e.g. the x-axis) of respective first and second images may be compared in accordance with a cross-correlation function that determines a similarity of the two image reductions as a function of a lateral shift of one image reduction relative to the other along the first axis. Accordingly, the lengthwise shift of one or more of the image reductions may correspond to a translation (e.g. in pixels, a percentage of pixels, or the like) of one image with respect to the other along the first axis. A profile feature in the similarity between the two image reductions as determined from the cross-correlation may thus relate to a transformation (e.g. a shift) of one image with respect to the other that would result in well-registered images upon their combination.

In some embodiments, a comparison of two images or reductions thereof (e.g. an assessment or calculation of similarity via a similarity function) comprises a self-correlation function. Such self-correlation is described below, but generally comprises determining a correlation between images of identical subject matter (i.e. the same image on itself). In such embodiments, method 10 may further include calculating a self-similarity profile for a first of the respective image reductions in accordance with a self-similarity function, and identifying a self-similarity profile feature in the self-similarity profile corresponding to a designated degree of similarity. In some embodiments, this step may occur before a cross-correlation function and profile is determined. Calculating a self-similarity profile (or otherwise performing a self-correlation step of method 10), may comprise images of same or similar subject matter (i.e. typically the same image) being self-correlated to determine whether suitable extrema can be identified (e.g. a degree of similarity exceeding a threshold), in turn indicative of whether a suitable potential image transformation can be identified. Thus, in some embodiments, self-correlation may be useful in identifying a reliable feature(s) of an overlap region of an image which can be considered a numerical landmark or feature point (although not necessarily a common pixel, as often found in feature-based registration). In some embodiments, self-correlation may provide an indication of the suitability of one or more of the images for subsequent registration steps. Additionally, in some embodiments, the method 10 may further comprise assigning weights to sub-images or sub-sub-images, as the case may be, wherein such weights are representative of the similarity in the self-similarity profile and hence, the reliability of the features contained in the image.

Advantageously, although not limited to this embodiment, performing a self-correlation step prior to any cross-correlation step prevents undertaking of an unnecessary cross-correlation step where two images cannot be aligned due to one or both images not being self-correlatable (e.g. due to a lack of distinguishing features, periodic features, or the like). Additionally, or alternatively, a self-correlation function may be useful in, for instance, normalising similarity values in order to more accurately assess a degree of similarity between different images (or image reductions). For example, a similarity function comparing different images may comprise as a normalisation term in turn comprising a self-similarity value or parameter as pertaining to one of the image reductions thereof being compared.

For example, periodic images (i.e. those containing features disposed periodically therethrough) may be challenging to register, as a translation of one image with respect to the other in a cross-correlation process may yield several suitable registration points corresponding to mismatches of periodic features. In such cases, a self-similarity process may provide an indication of whether or not a particular image reduction may be suitable for further processing, thereby potentially saving computational resources and time.

As mentioned above, some embodiments of method 10 may comprise calculating respective second image reductions along a second axis for each of the at least two images. In such embodiments, method 10 may further comprise, after calculating the respective second image reductions, determining a second similarity profile between the second image reductions in accordance with the similarity function. In one embodiment, the similarity function comprises a shift in a horizontal direction. After the similarity profile is determined based on the respective second image reductions, method 10 may further comprise identifying a second profile feature in the second similarity profile to further inform the image transformation.

As indicated, method 10 comprises identifying a first profile feature in the similarity profile to inform an image transformation for registering the at least two images. This may occur regardless of whether the similarity function included self-correlation, and regardless of whether a second profile feature was identified. The first profile feature may correspond with a maximum correlation between the at least two images. The first profile feature may be reflected in, for example, a graphic extremum such as a local or global minimum or maximum. In other embodiments, the first profile feature may be reflected in a zero-crossing. Otherwise, in simpler embodiments, the first profile feature may be reflected as a highest or lowest number in a numerical array, for example. In some embodiments, therefore, the first profile feature, may provide qualitative insight into the relationship between the at least two images (e.g. is there a correlation) and more quantitative insight into the image transformation or otherwise bringing about such relationship (e.g. what is the correlation).

The image transformation which is informed by the first profile feature, and optionally the second profile feature, corresponds to one or more of: a linear transformation, a non-linear transformation, a shift, a stretch, a skew, or a rotation, of one or more of the at least two images at least in part. As those skilled in the art will appreciate, the image transformation may seek to align or map the at least two images based on the similarity profile and more specifically, the first and/or second profile feature identified. In some embodiments, the image transformation may be carried over from the sub-image to the respective larger image to transform it with one or more other larger images.

Accordingly, in embodiments where the at least two images are of similar or same subject matter, the image transformation may comprise a transformation of at least one of the at least two images into another of the at least two images as a local image transformation. In embodiments where the at least two images are different images, such as in the case of two images of adjacent regions of a substrate (e.g. an integrated circuit) and comprising edge portions representative of a common region of the substrate, the image transformation may comprise a transformation of at least one of the at least two images in a designated reference frame. For example, one or more of the at least two images (or portions thereof) may be assigned a transformation within a global reference frame, which, in this context, may comprise one in which a plurality of images (e.g. two, tens, thousands of images) taken of a surface, substrate, object or other subject matter, may be aligned, assembled, registered or mapped based on method 10. In accordance with other embodiments, a transformation may relate to one in which one or more of the at least two images are translated, stretched, skewed, rotated, or the like, in a reference frame defined by one of the images. For example, and without limitation, a transformation may be assigned to a first of two images such that the first image is translated, stretched, skewed, rotated, or the like with respect the second image.

Regardless of the frame of reference in which images are registered, it will be appreciated that the process 10 may then be repeated to register any number of images, or portions thereof, with previously registered images. For example, thousands of tile images of a surface, object, or other matter may be registered sequentially (or at least partially in parallel via, for instance, parallel image processing techniques performed using a plurality of processing resources) wherein previously registered images may provide a frame of reference for the registration of subsequent images or images portions.

At 22, method 10 further comprises applying the image transformation to at least one of the two or more images. In some embodiments, this may seek to achieve a “best fit” between the at least two images, relative to one another and/or the global reference. In this embodiment, method 10, and in particular, the granularity of the intensity-based image reductions, may result in the image transformation comprising a pixel transformation of at least some pixels of one or more of the at least two images. Put differently, the at least two images may be registered with at least pixel accuracy. This granular resolution allows, for example, the at least two images to be aligned with one another and/or, further, to be aligned within a global reference with pixel accuracy and/or precision.

Those skilled in the art will appreciate that in the embodiment of FIG. 1, method 10 is operable as an intensity-based image registration method, with which a plurality of images or sub-images can be assembled, aligned, registered or mapped, within a global reference frame or otherwise, to form one or more larger images. Put differently, method 10 may be iteratively performed to determine the spatial distribution and/or relationship of sub-images within a global reference or otherwise, to assemble a larger combined image.

Those skilled in the art will readily appreciate, further, that method 10 may be operable in combination with a feature-based image registration method (e.g. a method in which distinct common features across a plurality of images are aligned). While various feature-based image registration methods are well known in the art, they traditionally suffer from various drawbacks. For instance, they typically require the presence of specific features (e.g. contacts in images of ICs) to facilitate image registration. Additionally, or alternatively, images comprising periodic or repeated patterns can complicate feature alignment. Yet further, the resolution of such feature-based image registering methods are typically limited. However, those skilled in the art will appreciate that combining the intensity-based image registration systems and methods of the present disclosure with feature-based image registration methods may improve accuracy of image registration overall.

It will be appreciated that, in accordance with some embodiments, the method 10 described with reference to FIG. 1 may be implemented by at least one processor in communication with a non-transitory computer readable medium, the non-transitory computer readable medium storing executable instructions related to the steps of the method, and an image storage database, the image storage database including at least the at least two images and, in some embodiments, the global reference.

Method 10, in this embodiment, ends at reference numeral 24. However, it will be appreciated that other embodiments or alternatives, such as those comprising additional steps before or after those of method 10, will be conceivable by those skilled in the art and are intended to fall well within the scope and nature of the present disclosure. Some of these embodiments or alternatives are briefly discussed below, without limitation.

In other embodiments, the at least two images may comprise images of a surface. For example, the surface may be any electronic circuit or part thereof. The utilisation of method 10 may be to register images of any surfaces, including surfaces representative of three-dimensional (3D) objects or stacked layers of 3D objects (discussed below). In one example, the surface may be a surface of a petri dish, of which a plurality of high definition resolution microscope images may be registered to assemble a complete representation of the petri dish surface in order to, for example, assess microbial growth on the petri dish surface. Other embodiments may relate to, for instance, mapping applications, wherein a plurality of images representative of a larger geographical area may be registered. In embodiments where the surface is of a 3D object, the at least two images may reflect the surface thereof in 2D data.

In yet a further embodiment, the at least two images may comprise a plurality of images taken of different sections of a sample (typically one or more biological materials) cut with a microtome. In such an embodiment, method 10 may be utilised to register images of each section to compile a registered 3D representation of the sample. Method 10 may be effective, for example, in reducing the noise caused by microtome cutting such that image processing requirements is reduced and/or simplified. In yet an additional embodiment, method 10 may be useful in ion milling processes, where the at least two images may comprise consecutive images of a substrate or material being milled and such images are registered by stacking consecutive images atop one another to provide a registered 3D representation of the substrate or material. Method 10 may be effective, for example, in registering these consecutive images despite only slight variations between consecutive images and/or despite the possible presence of repeated patterns. In yet a further embodiment, method 10 may be utilised to register a series of x-ray images taken from different angles around a body to yield registered cross-sectional images or slices of the various tissues of the body. Method 10 may thus be effective, for example, in improving the image registration used in conventional computerised tomography (CT) scans to obtain registered slices. These embodiments illustrate a selection of the various applications of method 10. In particular, these embodiments may illustrate that method 10 may be utilised first on a 2D plane, to register a plurality of images taken of a subject, and later any image transformations required on each image in the 2D plane may inform any image transformation(s) required to assemble the 3D representation. Furthermore, in some embodiments, method 10 may therefore be iterated for multiple images taken of a 3D subject, wherein the image registration comprises stacking of the 2D images to form a 3D representation of the subject.

In other embodiments, the at least two images may comprise subject matter of at least partially periodic features or patterns, with method 10 being capable of acquiring a first profile feature (and optionally a second profile feature) to inform image transformation(s) of such images. Notably, periodic features or patterns, or otherwise repeated patterns, are typically difficult to transform utilising conventional image registration methods due to the repetition of features and/or intensities in the images. However, embodiments of method 10 may be tailored, specifically designed, or indeed inherently suitable to transform images comprising at least partially periodic features or patterns. In particular, in some embodiments, method 10 may achieve this by, at 16, reducing the images containing periodic features or patterns to pixel intensities in either one or two axes. These image reductions may, in turn, be represented as profiles, and, at 18, thus allow the determination of a similarity profile via a similarity function between them. The similarity profile may exhibit sufficient resolution to identify a first profile feature (and optionally second profile feature) to inform image transformations, despite the presence of repetitive patterns, features, or pixel intensities. That is, by reducing the dimensionality of subject matter (e.g. 2D images), otherwise subtle differences between periodic or repeating structures may effectively be amplified and/or detected, thereby improving the specificity of a registration process for correctly matching specific features among a plurality of similar features, which is notoriously challenging for 2D image registration methods. As is described further below, even in instances where the presence of repetitive patterns, features, or pixel intensities in images may present an obstacle to image registration (i.e. the images are too “noisy” to easily determine a similarity profile via a similarity function or otherwise the similarity profiles obtained are too “noisy” to easily detect a profile feature therein), reducing such images to image reductions and optionally, similarity profiles, may still be useful in detecting such noise and/or providing an indicator that the specific selection of images is not good for image registration purposes. For example, in some embodiments, identifying particularly challenging repeating patterns from the image reductions of a sub-image (i.e. through self-correlation) may indicate that that particular sub-image is not good for image registration, but that an adjacent sub-image(s) of the same common region of interest may have sufficiently fewer repeating features to allow a reliable similarity function to be determined (and in turn, a profile feature) to inform image registration. In such embodiments, further processing power and/or time need not be expended on attempting to obtain a similarity profile and/or profile feature where other acceptable similarity profiles and/or profile features can be more easily obtained.

In other embodiments, the at least two images may be captured by any suitable image capturing hardware and/or software operable to acquire data related to a surface or substrate or other subject matter. It will be appreciated that such aspects may comprise resolution or other abilities suitable to the application at hand. For example, some embodiments relate to the acquisition of surface data at high-definition resolution. In some embodiments, the at least two images may be captured by optical, ion, and/or force microscopy techniques. Thus in different embodiments, the at least two images may comprise any one or more of optical images, thermal images, topography images, scanning probe microscopy (SPM) images, transmission electron microscopy (TEM) images, focused ion beam (FIB) images, atomic force microscopy (AFM) images, scanning tunnelling microscopy (STM), scanning confocal electron microscopy (SCEM) images, optical microscopy images, electron microscopy images, scanning probe microscopy images, laser imaging images, x-ray imaging images, or magnetic imaging images. In some embodiments, the at least two images may be captured by radar. It will be appreciated that various registration systems and methods herein described may be employed for various other applications, such as those relating to the provision of images over different length scales. For example, embodiments may relate to the registration of images comprising sub-micron features, wherein the collection of registered images may correspond to a substrate that is centimetres in length. Similarly, registration of images relating to features on the order of metres (e.g. radar images of weather, satellite imagery of the surface of the earth, or the like) may be registered to represent regions on the order of tens to thousands of kilometers.

In other embodiments, respective image reductions in a first axis and second axis may comprise image reductions of lines of pixels in the vertical axis and the horizontal axis, respectively, or vice versa. Additionally, or alternatively, an image reduction may relate to lines of pixels in a diagonal axis (e.g. top right to bottom left diagonal rows of an image). Notably, respective image reductions may be calculated for only a portion of each of the at least two images, such as a specific portion thereof to be transformed.

In yet other embodiments, method 10 may be equally useful for application to three-dimensional (3D) data sets, with the necessary adjustments intended to fall well within the scope of the present disclosure. In such embodiments, image data may comprise, for instance, voxel data. In some embodiments, the image reductions of the 3D data set or model may be calculated in three axes (x, y and z) before one or more extrema (e.g. three) may be identified. In other embodiments, the method may include reducing or projecting a 3D volume onto a line (i.e. linear data) in three ways (i.e. XY, YZ, or ZX) and comparing the projected pixel intensities obtained to determine a 3D transformation or otherwise required. In yet other embodiments, the 3D data set or model may be reduced to a 2D data set prior to image reductions in two axes being calculated to identify one or more extrema. It will be appreciated that such processes may similarly be implemented for applications having higher-dimensionality data of a substrate, such as those in which various points of a substrate characterised in 3D space are further characterised by other properties, such as composition, reflectivity, or the like.

In yet other embodiments, method 10 may include further post-processing steps directed to image registration either locally or globally. For example, in one embodiment, method 10 may include interpolating transformations of sub-images (or otherwise, image, portions of images, sub-sub-images, or the like) located between those calculated for sub-images. That is, in this embodiment, if a similarity function for two edges of a larger image are known, a transformation of a midpoint or other position of the larger image may be interpolated. Stated differently, execution of the method 10 for designated sub-regions of a larger spatial area may enable the inference of transformations (e.g. translations) for the areas in between those for which a transformation was calculated. As a non-limiting clarifying example, one may consider performing the process 10 on an image region corresponding to the top of a first image with respect to the bottom of a second image, wherein the bottom of the first image provides a spatial frame of reference. If it an optimal transformation for the top of the first image is determined to be a rightwards translation of 12 pixels, one may, in accordance with one embodiment, infer that the central region of the first image (i.e. image portions that are half way ‘up’ the first image) may be optimally translated by 6 pixels to the right (i.e. half of the horizontal translation determined for the top of the image). It will be appreciated that various interpolations may be performed, in accordance with various embodiments. For instance, and in accordance with one embodiment, one may perform a fit of transformations (e.g. x-translations) as a function position for a plurality of substrate positions and/or images (a plurality of x- or y-positions), wherein a resulting fit function may be used for interpolating or extrapolating transformations for other image regions. It will be appreciated that such inferences may be performed for more than one transformation (e.g. both for x- and y-translations, or the like), and that such functions may be linear or non-linear. For example, it may be determined that the degree of image stretching increases non-linearly in a particular dimension (e.g. the degree to which image portions of the same width are stretched increases as a function of position). Accordingly, such a process may effectively allow a user to ‘sample’ regions of, for instance, a substrate surface to determine large-scale effects of an imaging process (e.g. drift in electron microscopy imaging), while also reducing the computational effort and time associated with registering images by reducing the amount of image regions requiring registration.

It will therefore be appreciated that, in accordance with some embodiments, method 10 may include calculating an extrapolation curve based on similarity functions obtained for one or more images, from which a transformation at any point in the image can be interpolated or extrapolated (i.e. without determining a similarity function for that particular point). In yet another embodiment, method 10 may include applying a conformal map to a global image based on a similarity function or image transformation calculated for one or more sub-images (or otherwise, applying a conformal map to a sub-image based on a similarity function calculated for one or more sub-sub-images). In such embodiments, by tracking only the image transformations required in the common region of interest, and interpolating or extrapolating the image transformation (if any) required for the remainder of the image, less image transformations may need to be calculated and instead, less complex processing may be sufficient to register the images.

In some embodiments, post-processing steps may include, as described further below, applying an image transformation for a local image to a global image, considering that in some embodiments, registering two images (or sub-images or sub-sub-images, as the case may be) may result in one or both of those images no longer properly registering with other adjacent images in a mosaic. In other embodiments, however, post-processing steps in the form of applying an image transformation for a local image to a global image may not be necessary. In such embodiments, registration of the at least two images may be restricted to the common region of interest (i.e. the overlapping regions of each image) to maintain registration. Extending any image transformation required to register the images to the remainder of the image(s) and indeed, the remainder of images in the mosaic, may not be necessary in such embodiments. For example, and without limitation, an application related to the reverse engineering of ICs may comprise separately determining an internal electrical connectivity of elements within two adjacent distinct image tiles using, for instance, an image segmentation process. Having established an internal connectivity of circuit elements within each tile image, method 10 may then be applied to register the two image tiles to determine common features in a region of interest of each image, thereby assisting in the provision of connectivity between even those features that are not common to each tile, as connectivity in each tile is already known and preserved. It will be appreciated that other embodiments may relate to establishing such cross-tile connectivity in accordance with a different process sequence.

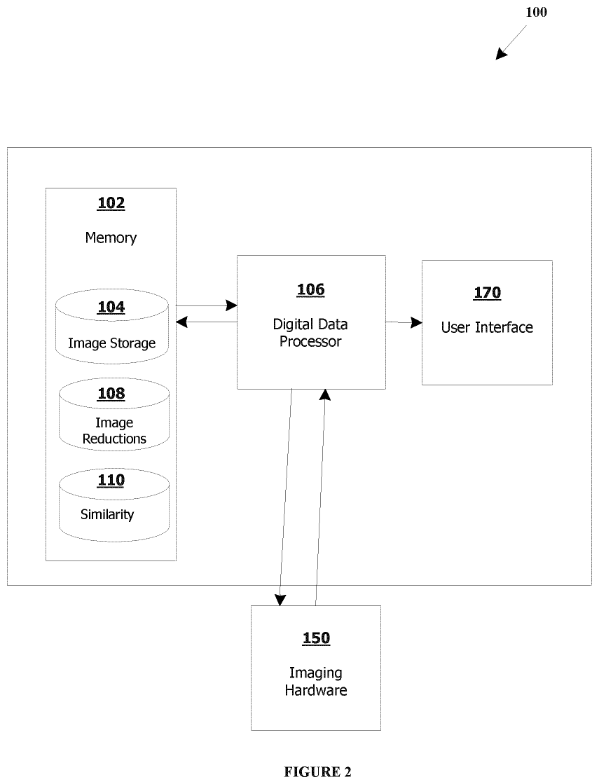

In FIG. 2, a digital image registration system in accordance with another aspect of the present disclosure, and generally referred to with reference numeral 100, will now be discussed.

System 100 is operable to register at least two images of a surface, the at least two images corresponding at least in part to a common region of the surface. System 100 comprises a memory 102 on which the at least two images are stored in an image storage database 104 and a digital data processor 106 communicatively coupled to memory 102 to retrieve the at least two images from said image storage database 104, and further operable to calculate respective image reductions for each of the at least two images along a first axis and optionally, along a second axis, determine a similarity profile between said respective image reductions in accordance with a similarity function, and identify a profile feature in said similarity profile to inform an image transformation for registering the at least two images.

As evident, digital data processor 106 is, in this embodiment, operable to execute steps resembling, at least partially, method 10 described with reference to FIG. 1. Accordingly, for the sake of brevity, the operations of digital data processor 106 are not repeated here.

As shown, in this embodiment, memory 102 includes an image reduction database 108 which stores image reductions calculated by digital data processor 106. Memory 102 may further include an image similarity database which stores similarity profiles and/or similarity functions determined for the at least two images. In addition, memory 102 may store the transformed images and/or the global reference frame (not shown).

In this embodiment, system 100 is shown operatively coupled with scanning electron microscope (SEM) imaging hardware 150. In this embodiment, system 100 is operable to obtain images from SEM 150, store images in memory 102, reduce images to image reductions via digital data processor 106 and determine one or more similarities to register the images against one another and/or the global reference frame. In some embodiments, the system 100 may perform such steps in real time, or near-real time.

In this embodiment, system 100 further comprises a user interface 170 operatively connected to digital data processor 106. In use, any one of the image transformation, the registered or transformed images, or the global reference frame may be displayed to a user via user interface 170.

Although not specifically illustrated, the present disclosure extends to a non-transitory computer-readable medium storing executable instructions, which, when executed by a digital data processor, are operable to retrieve at least two images corresponding at least in part to a common region of interest from an image storage database; calculate, via a digital data processor, respective image reductions for each of the at least two images along a first axis and optionally, along a second axis; determine, via said digital data processor, a similarity profile between said respective image reductions in accordance with a similarity function; and identify a profile feature in said similarity profile to inform an image transformation for registering the at least two images.

Those skilled in the art will understand this aspect of the disclosure to relate, for example, to the software at least partially enabling method 10 or system 100. The non-transitory computer-readable medium thus may include instructions directed to each of the features potentially forming part of method 10 or system 100, as described, as well as additional or complementary features which will be readily conceivable by those skilled in the art with reference to the present disclosure, such as the provision of a graphical user interface, associated digital processing and/or user manipulation tools, or the like.

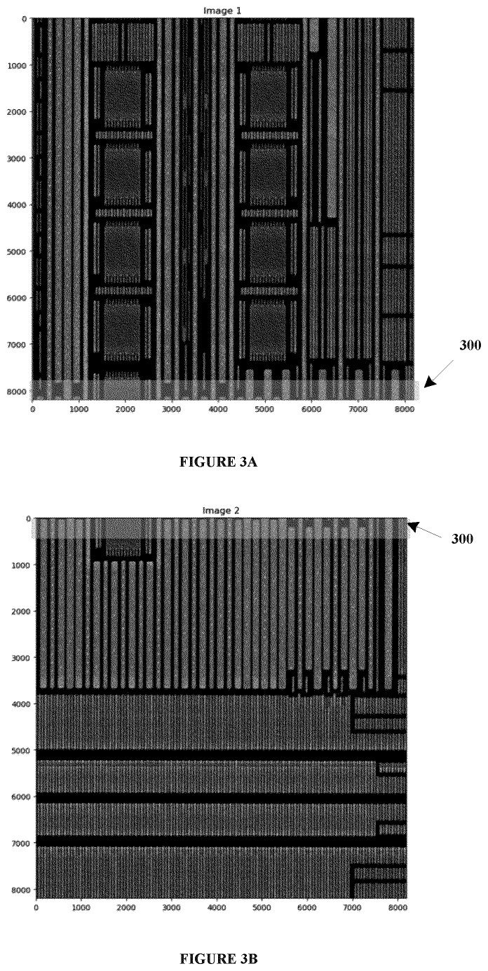

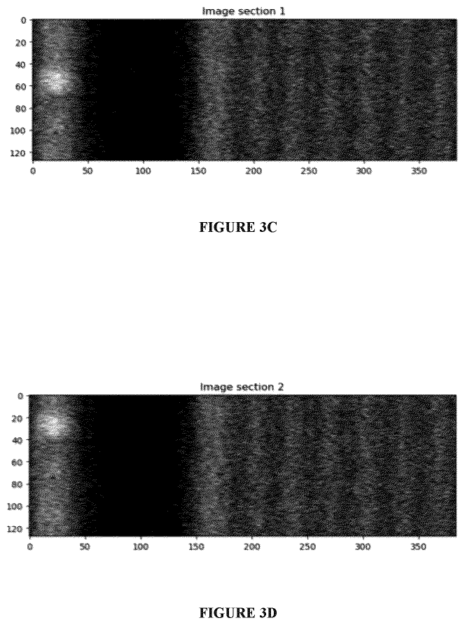

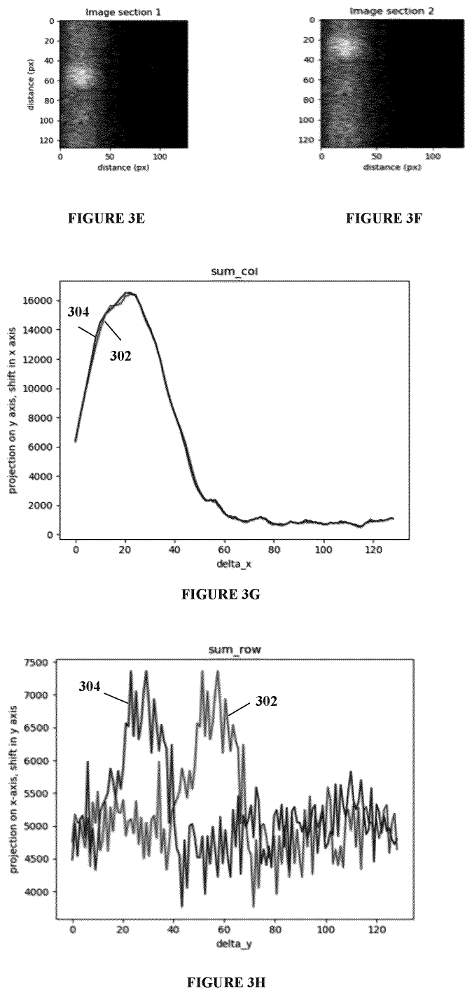

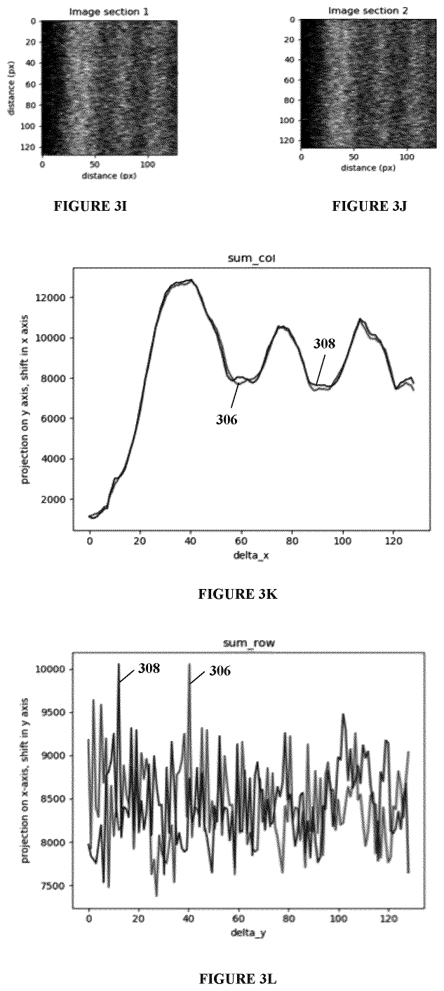

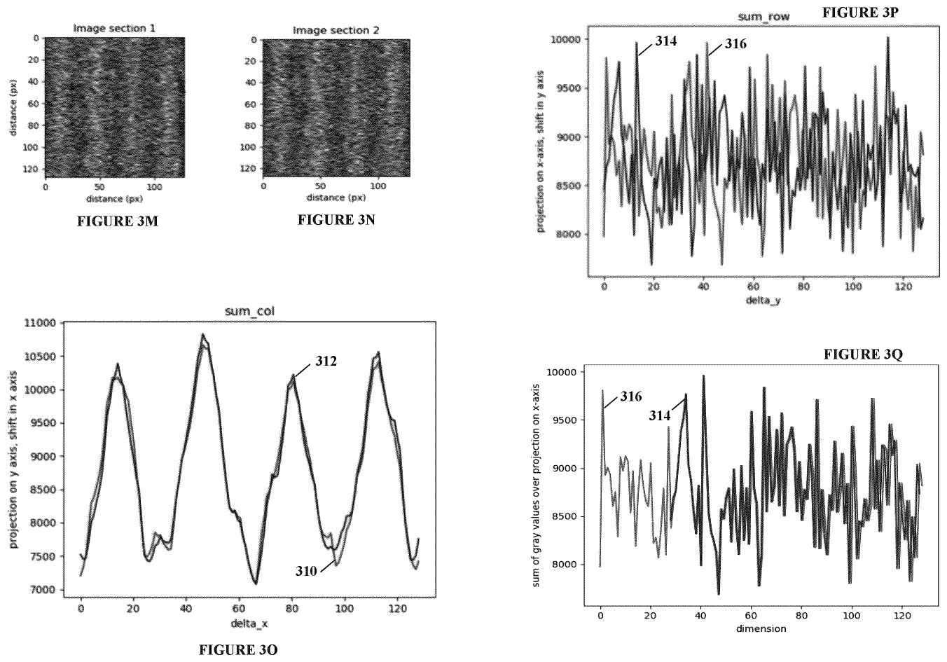

To exemplify method 10 in use, FIGS. 3 to 7 will now be discussed. Those skilled in the art, however, will appreciate that exemplary FIGS. 3 to 7 may be also applicable, mutatis mutandis, to exemplify system 100 and the non-transitory computer-readable medium storing executable instructions, and particularly, the common features between these different aspects of the present disclosure.

In FIG. 3, one embodiment of method 10 in use is illustrated through various examples.

FIGS. 3A and 3B are SEM images of an integrated circuit layer received from a SEM. As indicated, these images have high resolution, specifically 8K resolution, having a width of approximately 8,000 pixels in both the x- and y-axis, and in this example are the larger images mentioned above. The SEM images share a common region 300, indicated by the horizontal blocked region, at the bottom of FIG. 3A and the top of FIG. 3B. Although the potential alignment of these images may be apparent with visual observation, it is to be appreciated that alignment by a digital data processor may prove challenging, due to various reasons, some of which will be discussed below.

FIGS. 3C and 3D are sub-images of the respective larger images of FIGS. 3A and 3B, taken or defined from the common region 300. In this embodiment, the sub-images are of similar dimensions, as shown, each having close to 400 pixels in the x-axis and approximately 128 pixels in the y-axis.

Sub-images of the sub-images of FIGS. 3C and 3D are shown in FIGS. 3E and 3F—each reflecting a range of pixels of the sub-images shown in FIGS. 3C and 3D. For the purposes of this embodiment, these are herein referred to as sub-sub-images. However, it will be appreciated that the term ‘image’ may be understood as relating to a distinct or raw image, a sub-image, a sub-sub-image, or any other portion of an image, depending on the application at hand. For instance, various embodiments relate to the improved registration of ‘large’ images through the registration of smaller portions thereof (e.g. sub-images thereof), as further described below.

Returning again to FIGS. 3E and 3F, these sub-sub-images are again of similar dimensions, being generally square, each having close to 130 pixels in the x-axis and approximately 128 pixels in the y-axis. Again, observing these sub-sub-images with the human eye may reveal the potential alignment or matching of the two sub-sub-images—with both sub-sub-images having a solid band area and with the brighter “dot” appearing to be present in both sub-sub-images (although located slightly differently). However, it is to be appreciated that digital data processing of the same sub-sub-images may be more challenging and as such, alignment or matching of the two sub-images requires, in part, great processing power. Furthermore, when a plurality of pairs of sub-sub-images are to be matched or aligned, yet greater processing power is necessitated. Interestingly, in the sub-sub-images of FIGS. 3E and 3F, the brighter “dot” does not necessarily represent a specific feature (e.g. a transistor, a contact, or the like) on the integrated circuit layer. Instead, this artefact may only reflect a brighter “dot” in the reflection of electrons based on the composition of the integrated circuit layer. Accordingly, while not necessarily a functional feature within the circuit layer, it may nevertheless be real (i.e. not image ‘noise’), and as such, can still serve to inform the image transformation and/or image registration of the sub-images. As this brighter “dot” is not necessarily a functional feature (e.g. a contact), it may exhibit insufficient contrast from surrounding pixels to be successfully used in a conventional feature-based registration processes. There are also a large number of “speckles” visible on close inspection of FIGS. 3E and 3F, which are typically regarded as “noise”, although this may not necessarily be so, as indicated below.

In FIGS. 3G and 3H, different image reductions (also herein referred to as projections) of the sub-sub-images (shown in FIGS. 3E and 3F) are shown, as calculated by the method (10). In both Figures, the lines 302 show the image reduction obtained for FIG. 3E and the lines 304 show the image reduction obtained for FIG. 3F.

In FIG. 3G, image reductions along the x-axis (columns) of each of the sub-sub-images are calculated, and a similarity profile is calculated. In particular, in this example, for each sub-sub-image, the pixel values for each line in the x-axis (i.e. each column of pixels) are summed to produce image reductions in the x-axis. As such, a plurality of pixel values is obtained for each sub-sub-image, reflective of a summation of pixel values for each pixel coordinate in the x-axis. In FIG. 3G, the plurality of pixel values is plotted in a line graph or chart, for both sub-sub-images as separate lines, such that a similarity profile can be calculated therefrom (or from the raw values associated therewith) with a similarity function, which in this embodiment may correspond to a horizontal shift in the x-axis. Thus, FIG. 3G shows a plot with the x-axis reflecting the location (delta_x) of the summed column of pixels in the sub-sub-image, and the y-axis reflecting the value of the summation of the pixel values (in the x-axis of the sub-sub-images). In this example, the plots of the pixel reductions of the sub-sub-images of FIGS. 3E and 3F, specifically in the x-axis direction, align well, with little or no similarity function being required to register the sub-sub-images along the x-axis. It is notable from FIG. 3G that whilst the large distinct peak clearly reflects the brighter “dot”, other smaller discrete features or trends in the graph, such as from pixel 50 to pixel 120, are also shown to align or match between lines 302 and 304. Referring back to FIGS. 3E and 3F, these features correspond to mere “speckles” in the sub-sub-images, or what appears to be “noise”, which collectively increase intensity value for each pixel line (in both axes, depending on the reduction made). Accordingly, even such non-distinct features may be identifiable from the image reductions (or projections) as shown, and may correlate, match or align between the different sub-sub-images. Accordingly, “speckles” or other imaging artefacts traditionally regarded as “noise” may assist in the image transformation to align the sub-sub-images once reduced in one or more axes (and thus, may not be necessarily considered “noise”). In particular, the grain pattern may be utilised to identify similarities.

In FIG. 3H, image reductions along the y-axis of each of the sub-sub-images are calculated. In particular, in this example, for each sub-sub-image, the pixel values for each line in the y-axis (i.e. each row of pixels) are summed to produce the image reductions in the y-axis. As such, a plurality of pixel values is obtained for each sub-sub-image, reflective of a summation of pixel values for each pixel coordinate in the y-axis. In FIG. 3H, the plurality of pixel values is plotted in a line graph or chart, for both sub-sub-images as separate lines, with the x-axis reflecting the location (delta_y) of the summed row of pixels in the sub-sub-image and the y-axis reflecting the value of the summation of the pixel values (in the y-axis of the sub-sub-images). From these image reductions, it is again evident that the “brighter” dot is identifiable in both lines 302 and 304, although comprising a plurality of large peaks (between 20 pixels and 70 pixels on x-axis). On closer inspection, it is also evident that the “speckles” are identifiable in lines 302 and 304 from the corresponding smaller peaks (between 40 pixels and 130 pixels in the x-axis). A similarity profile may be calculated from the plot, or the raw values associated therewith, which may in this instance correspond to a shift in y-axis (of the images). On visual inspection, however, the plots are not well-aligned and it appears as if the sub-sub-images of FIGS. 3E and 3F are shifted in the y-axis direction with respect to one another. Thus, whilst the plot profiles are similar overall but differentially spaced, a similarity function in the form of a vertical shift in the y-axis may be necessary to register the sub-sub-images in the y-axis (corresponding to aligning the “dots” in the y-axis direction).

Advantageously, calculating image reductions (or projections) for both sub-sub-images reduces data requiring comparison for image registration. In particular, instead of comparing two-dimensional images or pixel values in two-dimensions, the sub-images are each reduced in one axis (i.e. in the x-axis or the y-axis) to one-dimensional arrays which can be compared with less computing power. On visual inspection, it is evident that the image reductions in this manner may be beneficial in identifying alignment. In this example, the image reductions are not well-aligned in the y-axis direction as shown. In other embodiments, to further improve the image transformation or image registration, as the case may be, the sub-images can be further compared by reducing each of them in another axis (i.e. in both the x-axis and the y-axis) for further comparison. In such embodiments, both a first profile feature and a second profile feature may be identified when a similarity profile is determined from the image reductions in two axes, each profile feature with reference to the comparison in a different axis.

Although not specifically shown, in both FIGS. 3G and 3H, a similarity profile can be calculated with a similarity function from the image reductions. In this particular example, as described, the similarity function may be a shift or translation in the y-axis to obtain a “best alignment” between the lines reflecting the image reductions of each image. Accordingly, based on visual inspection to reflect the principle of the similarity function, this shift may be of a magnitude of approximately 40 pixels in the y-axis direction. Examples of similarity profiles are discussed below. Again, although not shown, obtaining a similarity profile for FIGS. 3G and 3H may lead to being able to identify a first profile feature in the similarity profile (which may also be identifiable from the raw data of the image reductions) after the similarity function has been applied. The first profile feature typically refers to a maximum correlation between the image reductions of each of the sub-sub-images. Once identified, as described, the first profile feature in the similarity profile informs an image transformation for registering the sub-sub-images. Examples of identifying first profile feature are discussed below. Registration of the sub-sub-images locally may in turn inform a global image transformation of the larger images.

In FIGS. 3I and 3J, other sub-sub-images of the sub-images of FIGS. 3C and 3D are shown-again having similar square dimensions. In this example, each sub-sub-image comprises exhibits, as may be apparent by visual inspection, a partially periodic pattern (or repeated bands) of the sub-images shown in FIGS. 3C and 3D (i.e. approximately from pixel 125 to 250). Moreover, while such bands may generally be detectable to the human eye, the relatively high degree of image noise typically would render these images challenging to register using conventional registration methods. In particular, the relatively high degree of image noise would make two-dimensional registration of the images much harder, whereas in some embodiments, additional noise may make two-dimensional registration impossible. In such embodiments, the methods disclosed herein may be useful in registering the images with the image reductions (projections), and may be a reliable tool even in the presence of high “noise”, as will be elucidated further below.

In FIGS. 3K and 3L, different image reductions of the sub-sub-images shown in FIGS. 3I and 3J are shown, as calculated by the method 10. In both Figures, lines 306 show the image reduction of FIG. 3I and lines 308 show the image reduction of FIG. 3J. In FIG. 3K, image reductions along the x-axis of each of the sub-sub-images of FIGS. 3I and 3J are calculated by summation of the pixel values for each line in the x-axis (i.e. each column of pixels). In FIG. 3K, the plurality of pixel values for each column are plotted in a line graph or chart (separate functions for each sub-sub-image), with the x-axis of the plot reflecting the location (delta_x) in the sub-image and the y-axis of the plot reflecting the summation of the pixel values (in the x-axis of the sub-images). Again, the similarity between the sub-sub-images in the x-axis is evident from the plot and thus, minimal adjustments to the sub-sub-images in the x-axis direction will likely be required. In FIG. 3L, image reductions along the y-axis of each of the sub-sub-images of FIGS. 3I and 3J are calculated by summation of the pixel values for each line in the x-axis (i.e. each row of pixels). In FIG. 3L, the plurality of pixel values for each row are plotted in a line graph or chart, with the x-axis of the plot reflecting the location (delta_y) in the sub-sub-image and the y-axis of the plot reflecting the summation of the pixel values (in the y-axis of the sub-sub-images). Separate functions are plotted for each sub-sub-image and as shown, although a similarity between the sub-sub-images in the y-axis can be identified, adjustments in the y-axis direction will likely be required to obtain a “best alignment” between the sub-sub-images (which adjustment can be calculated with similarity function, as discussed below).

FIGS. 3M and 3N show other sub-sub-images of the sub-images of FIGS. 3C and 3D-reflecting a periodic pattern (or repeated pattern). Moreover, these sub-images exhibit a high degree of noise relative to the intensity of features therein (i.e. exhibit a low SNR). Typically, registering images containing such repeated patterns and noise requires intense computer processing and/or processing time. In some instances, registration of such images may even be impossible with conventional methods (e.g. due to the large amount of noise).

In FIG. 3O, line 310 shows a first image reduction summing all columns of pixels in FIG. 3M, and line 312 shows a first image reduction summing all columns of pixels in FIG. 3N. In this example, as shown, the respective column-wise image reductions of FIGS. 3M and 3N appear to be aligned on this scale as a matter of chance or coincidence (without any shift or otherwise required for alignment), in turn reflecting the similarity of the sub-sub-images of FIGS. 3M and 3N in a column-wise direction. It is to be appreciated, however, that such coincidental alignment in one axis may not always be the case when plotting “pure” image reductions of sub-sub-images. Indeed, in this case and on another scale, a minor horizontal shift of one or two pixels may improve the alignment between these image reductions (not visible on this scale). The plot of FIG. 3P shows images reductions 314 and 316 corresponding to summations of the rows of FIGS. 3M and 3N, respectively. In this axis, as shown, the respective row-wise image reductions of FIGS. 3M and 3N appear to align poorly, yet still reflect a similarity which can be extracted or determined. In contrast to the plot of FIG. 3O, this initial result of the “pure” image reductions of the respective sub-sub-images is somewhat more typical, wherein further processing is required to obtain an improved (or any) alignment. Using plots and/or datasets such as those of FIGS. 3O and 3P, method 10 may identify a similarity profile and/or function for even pure repeated patterns. In particular, from FIG. 3O, a high similarity between the images in the x-axis direction (i.e. columns) is evident, as mentioned, whilst FIG. 3P reveals that a vertical shift in the y-axis direction may be required to obtain a “best alignment” between the sub-sub-images (thus, to stitch the image reductions together). Furthermore, the sub-sub-images of FIGS. 3M and 3N include a high level of noise which normally poses a hurdle to image registration. However, as indicated, image registration is still possible on typically “noisy” images with method 10. Put differently, using method 10 (i.e. reducing the two-dimensional image into one-dimension in two axes) reveals a (more or less) alignment in the x-axis direction already. However, a conventional two-dimensional method would likely often fail to detect such alignment due to the consideration of similarity of all pixels in two-dimensions, or otherwise, would only obtain a poor alignment. As such, with conventional methods, the “noise” would likely result in a) not hitting an acceptable threshold of similarity, b) finding a large number of similarly good transformations, and/or c) selecting the “best” transformation that, by coincidence and because of noise, is incorrect.

FIGS. 3M and 3N (as well as further embodiments illustrated below) therefore illustrate inter alia that the image reductions average down the “noise” of images, particularly of high resolution, whilst preserving the grain pattern. A similarity with respect to the grain pattern can therefore be extracted (discussed with reference to FIG. 3Q below) which may be useful in repeated pattern cases, where the grain pattern may distinguish otherwise identical features in the images.

FIG. 3Q shows an example of how an image transformation obtained from a similarity profile may enable or improve image registration. In this example, a similarity profile was calculated for the “pure” image reductions of FIG. 3P. In particular, an extremum in a similarity profile was identified corresponding to an offset of approximately 40 pixels between image reductions. That is, the profile feature in the similarity profile, in this case a maximum in a cross-correlation of reductions 314 and 316, indicated that a best alignment would be provided by translating the image of FIG. 3N (corresponding to the reduction 316) by approximately 40 pixels to the left. This is highlighted by FIG. 3Q, which shows excellent alignment of the image reductions 314 and 316 upon a leftwards translation of reduction 316 (thus “stitching” the image reductions together to obtain the best alignment). This alignment thus illustrates that the signals obtained from FIGS. 3M and 3N correlate well, despite the calculation of image reductions in the y-axis direction (i.e. rows) appearing “noisy”, or the 2D images themselves being challenging if not impossible to register using conventional methods.

As further illustrated by the above example, it may be possible that “pure” or original image reductions from sub-sub-images align by chance or coincidentally, whilst in other cases, a translation, stretch, rotation or other adjustment to one or both image reductions may be required to align the image reductions, in turn reflecting the image transformation required to register the sub-sub-images or larger images of which they form part. In particular, in the above example, FIG. 3O coincidentally aligned (on visual inspection at that scale, although slight translation may achieve best alignment as discussed) whereas FIG. 3P did not align and thus required a horizontal shift as discussed to yield FIG. 3Q.

In other embodiments, as will now be described, method 10 may include a step wherein the similarity function comprises a normalised cross-correlation (NCC). The NCC may include any one or both of self-correlation and/or cross-correlation, as will be described. In this embodiment, the type of NCC to be applied is different depending on whether the images have been reduced to one-dimension or two-dimensions (of image reductions). If two-dimensional image reductions have been calculated, such as the case with many conventional image registration methods, the following formula for the NCC is utilised:

$${C}_{N} ( k , l ) = \frac{{Σ}_{m = 0}^{M - 1} {Σ}_{n = 0}^{N - 1} {I}_{1} ( m , n ) {I}_{2} ( m + k , n + l )}{\sqrt{{Σ}_{m = 0}^{M - 1} {Σ}_{n = 0}^{N - 1} {{I}_{1} ( m , n )}^{2}} \sqrt{{Σ}_{m = 0}^{M - 1} {Σ}_{n = 0}^{N - 1} {{I}_{2} ( m + k , n + l )}^{2}}} \qquad \underline{Formula 1 :}$$

If a one-dimensional image reduction has been calculated, such is the case in this embodiment, the following formula for the NCC is utilised:

$${C}_{N} ( col - wise projection ) = \frac{{\sum }_{n = 0}^{N - 1} {I}_{1} ( n ) {I}_{2} ( n + l )}{\sqrt{{\sum }_{n = 0}^{N - 1} {{I}_{2} ( n + l )}^{2}} \sqrt{{\sum }_{n = 0}^{N - 1} {{I}_{1} ( n )}^{2}}} \qquad \underline{Formula 2 :}$$

In the Formulae above, the numerators represent, broadly, the calculation of the similarity function between the image reductions of the at least two images (i.e. cross-correlation), determined as a function of the summation of pixels along a given row or column of pixels in each image. The denominator, in turn, represents broadly the normalisation thereof (i.e. self-correlation), related to a self-correlation of the second image reduction. More specifically, in these formulae, “I₁” and “I₂” denote respective first and second images of the at least two images being compared; “m” denotes a particular co-ordinate in one axis (e.g. columns) and “M” denotes the upper boundary thereof (the lower boundary being zero); similarly “n” denotes a particular co-ordinate in another axis (e.g. rows) and “N” denotes the upper boundary thereof (the lower boundary being zero); and “k” and “/” denote incremental variables representative of the image transformation (e.g. shift), wherein such increments are assumed to be 1. Based on the foregoing, 0 . . . . M and 0 . . . . N are effectively the domain of images “I₁” and “I₂”. As is readily appreciable from the Formulae, Formula 2 is computationally simpler as compared to Formula 1, thus requiring less processing power and being preferable in some embodiments. While Formulae 1 and 2 relate to similarity functions comprising a normalised cross-correlation (NCC), it will be appreciated that other forms of comparison by way of a similarity function may be employed in accordance with various embodiments. For example, a similarity function may relate to a self-correlation, a sum-of-squares difference, a convolution, a Fourier transformation, a bivariate correlation, or the like. Utilising a bivariate correlation (i.e. Pearson's r) as the similarity function, for example, may be particularly useful as it normalises to a range of −1.0 to 1.0, facilitating for example, comparison of similarity functions obtained for images to a predetermined threshold of similarity required or desired. In turn, ensuring a predetermined threshold of similarity is met may further facilitate later image registration wherein, for example, a similarity function is used to inform a global reference frame. Accordingly, while embodiments may be described herein with reference to the employ of an NCC, it will be understood that, in accordance with other embodiments, other similarity functions may be employed without departing from the general scope or nature of the disclosure. For example, it will be appreciated that various embodiments may comprise other functions or otherwise that may be easily insertable (and/or replacing other functions) to define other similarity functions. For example, where the similarity function comprises skewing, a variable coefficient may be inserted before an appropriate co-ordinate or term to identify the similarity function based on a coefficient of skewing. However, those skilled in the art will appreciate that stretching is typically preferable to skewing in two dimensions (although skewing may be workable in alternative embodiments), as stretching works in both one dimension and two dimensions. Those skilled in the art will also appreciate the range of functions representing similarity functions which may be interchangeable with the above Formulae, forming various alternative similarity functions in accordance with various embodiments, which are intended to fall well within the scope of the present disclosure. For example, different similarity functions may comprise additional terms, coefficients, normalisation factors, or the like, in accordance with different embodiments.

The systems and methods herein described provide several advantages over conventional registration processes. For example, conventional 2D image registration processes may employ an iterative comparison similar to that of Formula 1 above. The time required for image registration using such methods may accordingly scale with the area of images to be registered (i.e. order O(l x w), where l and w are the length and width of an image, respectively). Conversely, by reducing 2D images to be compared to 1D image reductions, image comparison, such as that performed using a similarity function akin to that of Formula 2, may lead to a reduction in time taken to compute the similarity profile and in turn, reduce computational costs of registering images. In some instances, although reducing the 2D images to 1D images reductions (i.e. calculating image reduction along one and optionally two axes) may appear to add time to the overall image registration process, this additional time is typically insignificant as compared to the reduction in time afforded by doing the determining the similarity profile based on the image reduced in 1D.

Accordingly, in one embodiment, the NCC of Formula 2 is applied on the image reductions in the x-axis (or the y-axis) in order to find the first profile feature in similarity (and/or maximum correlation) in one-dimension, as opposed to two-dimensions. One-dimensional identification of the first profile feature (or, in some cases, the maximum correlation) may be advantageous, in some embodiments, to reduce processing power required and/or increase speed with which images may be registered.

Furthermore, the reduction of, for instance, 2D image data to a 1D image reduction may effectively reduce image noise, and thereby improve a quality of registration. For example, summing columns (or rows) of pixels in images to reduce a 2D distribution of pixel intensities to a single 1D array of summed pixel intensities may effectively reduce stochastic noise, which notoriously presents a challenge in conventional registration techniques. That is, when 2D images are conventionally registered in 2D, random noise may give rise to registration mismatches, as a strong correlation may be challenging to identify due to a lack of a strong correlation at a correct registration position, and (sometimes many) relatively strong correlations at incorrect registration positions. Such issues are at least partially mitigated in the embodiments herein described, wherein image reductions provide an inherent means of filtering noise (without necessarily employing additional signal filtering processes), effectively improving signal-to-noise in registration processes, and thereby improving a quality thereof.

In accordance with various embodiments, the systems and processes herein described may provide further advantages over conventional image registration techniques. For example, various embodiments relate to the registration of larger images, or portions thereof, via registration of sub-images thereof of smaller size. The registration of such sub-images may improve registration of larger images by, for instance, reducing a number of pixel values and/or features in an image that are correlated in a digital registration process, thereby reducing the possibility that the registration process or system will assign an incorrect transformation to one or more of the images for registration. For example, as the size of images being registered increases, the relative weight of appropriately matched features or pixels decreases in a digital comparison and/or evaluation of a similarity function. This may accordingly decrease the ability of a digital registration process to identify a correct transformation to register images in view of image noise and other mismatches in pixel values corresponding to the same region of interest (whether a surface, substrate, object or other subject matter) acquired in different images. This advantage may be more readily apparent in consideration of, for instance, attempting to register the common region 300 of FIGS. 3A and 3B. A digital process attempting to register the entirety of the common region 300 may be challenging, even if performing registration using image reductions of the entire area. For example, image reductions obtained by summing the all rows of pixels of the common region 300 (e.g. reducing the image to the y-axis) may yield reduction profiles for each image that are invariant or comprise no distinguishing features with which a similarity process (e.g. a cross-correlation) may yield a preferred transformation. That is, during an image reduction, the sheer number of pixels summed in each row from all circuit features present in the common region 300 may effectively wash out any subtleties, or common pixels or features in each image from which a registration process may determine an accurate registration transformation. Conversely, the sub-images in 3E and 3F comprise few enough pixels that the ‘bright dot’ described above is clearly represented in both reductions in FIG. 3H. Accordingly, while a registration of the entire common region 300 of FIGS. 3A and 3B would be challenging, registration of the sub-images of FIGS. 3E and 3F would be relatively straightforward using the embodiments herein described.

Moreover, by registering smaller complementary sub-images, the computational cost (e.g. time) associated with registering large images may be reduced. Continuing with the example of FIGS. 3A to 3P, the computational time to register the sub-images of 3E and 3F will naturally be less that that required to register the entire common region 300 of FIGS. 3A and 3B.

A yet further advantage of such embodiments is that a quality of registration of large regions may be improved through the respective registration different sub-images thereof. For example, it is appreciated that electron microscopy may produce images with various distortions, wherein the spatial integrity of resulting images is not necessarily preserved over the entirety of an imaging region. That is, as, for instance, imaging components or substrates drift, or conditions change over the course of imaging, the interpreted positions of features recorded as pixel values in an image may similarly drift, resulting in image skew or distortion. This may result in, for instance, regions in the top-left of an image corresponding to a different imaging condition, a relationship between image pixel pitch and physical distance, or the like, being different from those in the bottom-right of an imaging region. The registration of sub-images, however, may in part mitigate these effects by determining local registrations at respective regions of the substrate, rather than attempting to apply a single transformation to an entire large region to achieve a global registration.

Consider, for example, that an imaging process results in a first pixel pitch-to-physical distance coefficient on the left-hand-side of an image, and a second, larger pixel pitch-to-physical distance coefficient on the right-hand-side of an image. A conventional process for registering these images may determine a global transformation that, for instance, translates one image with respect to another in a global reference frame. However, this global transformation may result in only a portion of each image being properly registered, as other regions of each image were differently ‘stretched’. However, by defining a plurality of sub-images from the larger images, a registration process may evaluate each sub-region to determine an appropriate respective local transformation therefor for accurate registration, which, collectively, may result in an improved registration of the entire larger image from which the sub-images are defined. It will be appreciated that, in accordance with various embodiments, such local transformations may be applied to other regions of the larger images. For example, a local transformation in a first axis (e.g. from left to right) to register a sub-image may then be applied to other regions of the larger images (e.g. all portions of the image characterised by the same x-coordinates). Similarly, such registration of sub-images may be performed along, for instance, the left edge of an image, wherein sub-images along this edge may be processed to determine respective local transformations in the y-axis which are then applied to all regions of the larger image sharing y-coordinates of each respective sub-image. It will be appreciated that such embodiments may further reduce computational time while increasing a quality of registration of large images by applying local transformations computed for sub-regions thereof.

It will be appreciated that sub-images may comprise different geometries, in accordance with different embodiments. In one embodiment, the NCC is applied on a square sub-image and a rectangular sub-image from the common region of the larger image. Advantageously, having sub-images of differing dimensions allows a degree of freedom in calculating the similarity profile with the similarity function (e.g. in shifting the images lengthwise with reference to each other to calculate a similarity profile and identify the first profile feature which in turn, reflects a shift of one image with respect to the other along one axis to improve registration).

To further illustrate the systems and methods herein disclosed, various further exemplary embodiments will now be described.

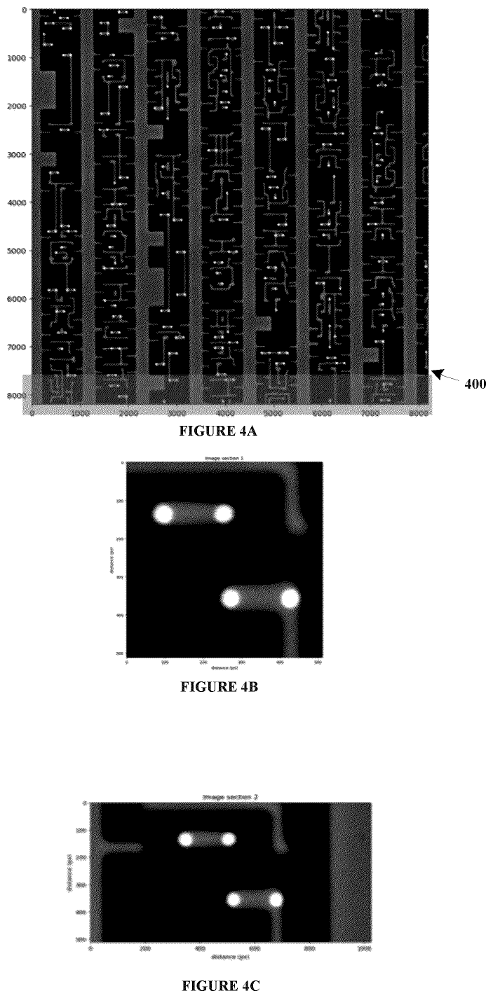

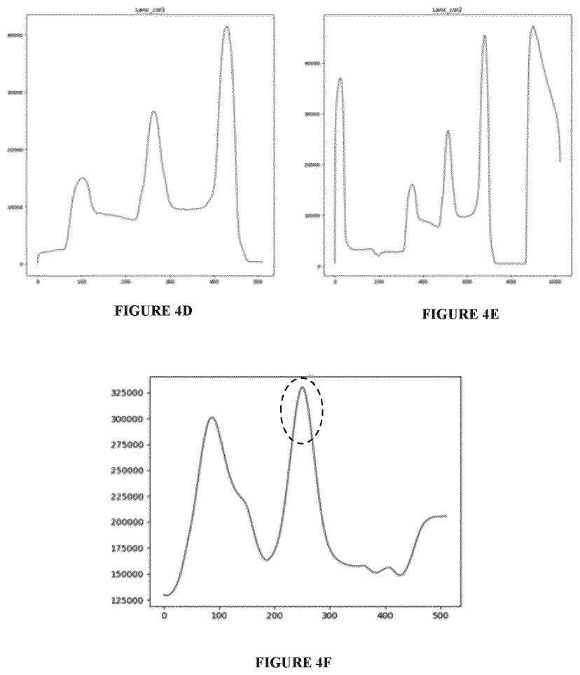

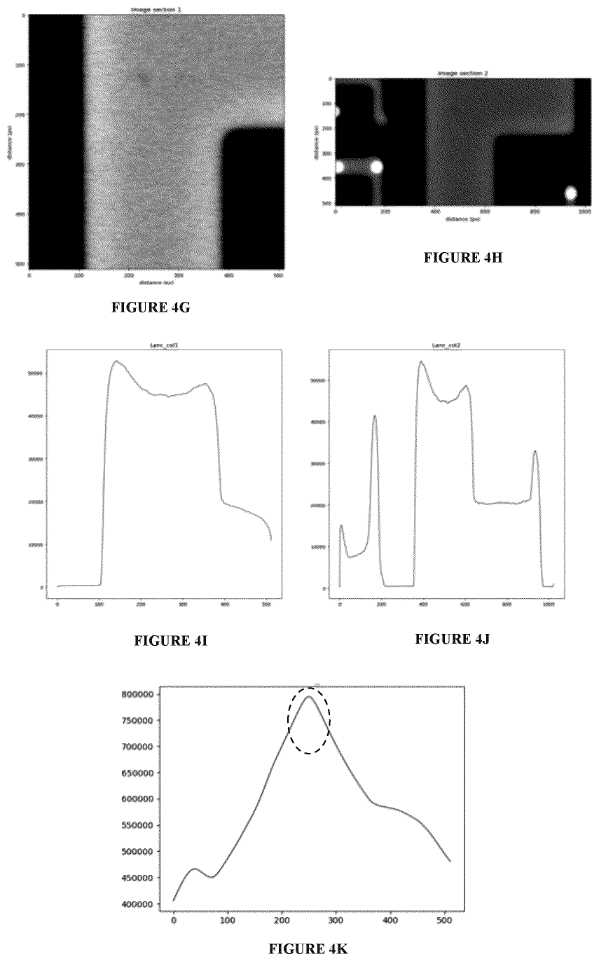

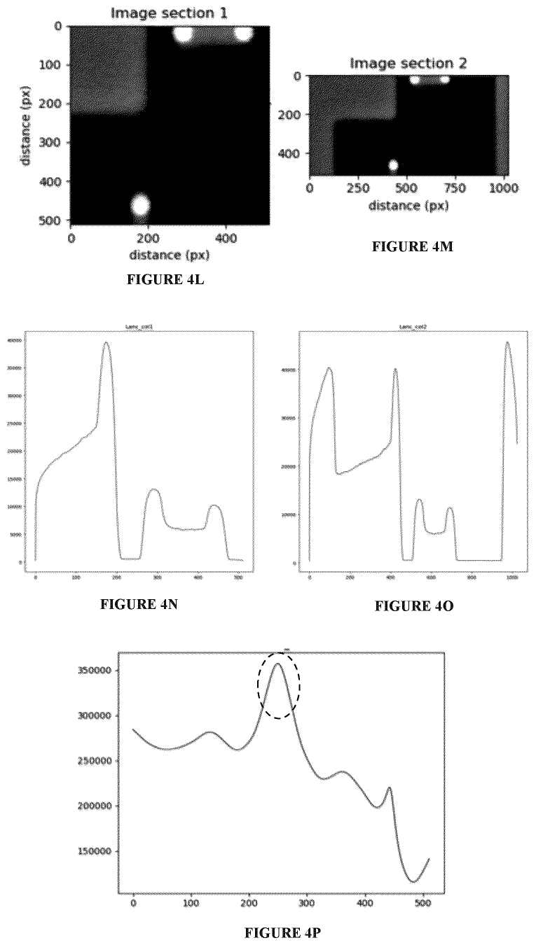

In FIGS. 4A to 4P, one embodiment of a self-correlation is illustrated, in particular as a cross-correlation, for three different pairs of images taken from a larger image to be registered.

In FIG. 4A, a larger image of an integrated circuit layer is shown. As indicated, the larger image has high resolution, specifically an image resolution of 8K and a region which is to be registered is blocked 400. In FIGS. 4B and 4C, two sub-images of the larger image of 4A are shown, particularly being sub-images taken from blocked region 400. In particular, FIG. 4B shows a square sub-image with dimensions of approximately 510 pixels in each axis and FIG. 4C shows a rectangular sub-image with dimensions of approximately 510 pixels by approximately 1010 pixels.

In FIGS. 4D and 4E, image reductions for each of the sub-images have been calculated in the x-axis. In other words, pixel intensities of each column in the x-axis have been summed to provide image reductions of the sub-images. These image reductions are plotted on separate line graphs or charts, as shown in FIGS. 4D and 4E, where FIG. 4D reflects the image reductions from FIG. 4B and FIG. 4E reflects the image reductions from FIG. 4C. As can be observed, the peaks in FIGS. 4D and 4E reflect brighter spots on the sub-images of FIGS. 4C and 4D. Again, it is to be appreciated that although a clear similarity between the sub-images is recognisable under the human eye, such similarity is not necessarily so easily recognised with a computer or image processing technology, a challenge that would be even greater using conventional 2D registration methods that do not employ the image reductions.

In FIG. 4F, a similarity profile of the image reductions of FIGS. 4D and 4E is calculated using a similarity function, which can comprise any one or more of a shift, a skew etc., as described above. In this particular example, the similarity function comprises normalised cross-correlation corresponding to a lengthwise shift of the plots of FIG. 4D and FIG. 4E. As observable, a first profile feature can be identified as a distinct peak or maximum (dashed circle) which reflects a maximum correlation between the two image reductions of FIGS. 4D and 4E. As indicated, the first profile feature presents at between 200 and 300 pixels, corresponds to a maximal correlation of the image reductions, which in turn corresponds to a proper alignment of the sub-images of 4B and 4C in the x-axis. To the human eye, this alignment corresponds to the alignment of bright features of the sub-images, which, to a digital registration process, provide numerical landmarks which can be used to inform an image transformation for registering the sub-images.

Advantageously, as illustrated with this example, calculating image reductions simplifies the step of calculating a similarity profile between the respective image reductions in accordance with a similarity function, particularly when subject matter of the images comprises at least partially periodic patterns (or combinations of solid and repeated patterns). In turn, this simplifies the step of identifying a first profile feature (and/or a second profile feature where necessary).

It will be appreciated that while the exemplary embodiment of FIGS. 4B to 4F illustrates how the reduction of images along a first axis may be used to inform a transformation of one or more sub-images along this first axis (e.g. a relative translation along the x-axis) for improved registration, the process may then be repeated along a second axis (e.g. the y-axis) to further inform a transformation of one or more images along the second axis. For example, by performing the steps of method 10 of FIG. 1 in both the x- and y-axes, images may be registered in two dimensions by, for instance, combining the respective transformations determined for each axis.

FIGS. 4G to 4K provides another exemplary embodiment, similar to FIGS. 4B to 4F. FIGS. 4G and 4H are two further exemplary sub-images of differing dimensions defined from the SEM image of FIG. 4A, taken from blocked region 400 and sharing similar features as can be visually observed. Visual inspection may reveal a potential scale difference between the sub-images. FIGS. 4I and 4J are plots representing image reductions of the sub-images of FIGS. 4G and 4H, respectively, reduced or projected onto the x-axis for summed pixel brightness of columns. FIG. 4K is a plot representing an exemplary cross-correlation of the image reductions of FIGS. 4I and 4J, thus reflecting the similarity profile of the sub-images of FIGS. 4G and 4H and a first profile feature of the similarity profile which is indicated in broken lines. This similarity profile and first profile feature may be utilised to register FIGS. 4G and/or 4H with reference to one another or other images, or otherwise, may be utilised to register FIG. 4A within a global reference.

FIGS. 4L and 4M are two yet further exemplary sub-images of differing dimensions defined from the SEM image of FIG. 4A, taken from blocked region 400. FIGS. 4N and 4O are plots representing exemplary image reductions of the sub-images of FIGS. 4L and 4M, respectively, reduced or projected onto the x-axis for summed pixel brightness of columns. Visual comparison reveals peaks in FIGS. 4N and 4O correspond to brighter regions or “dots” in FIGS. 4L and 4M. FIG. 4P is a plot representing an exemplary cross-correlation of the image reductions of FIGS. 4N and 40, thus reflecting the similarity profile of the sub-images of FIGS. 4L and 4M and a first profile feature in the similarity profile indicated in broken lines. Once again, this first profile feature may inform registration of FIGS. 4L and/or 4M with respect to one another or other sub-images, or otherwise, may be utilised to register FIG. 4A within a global reference.

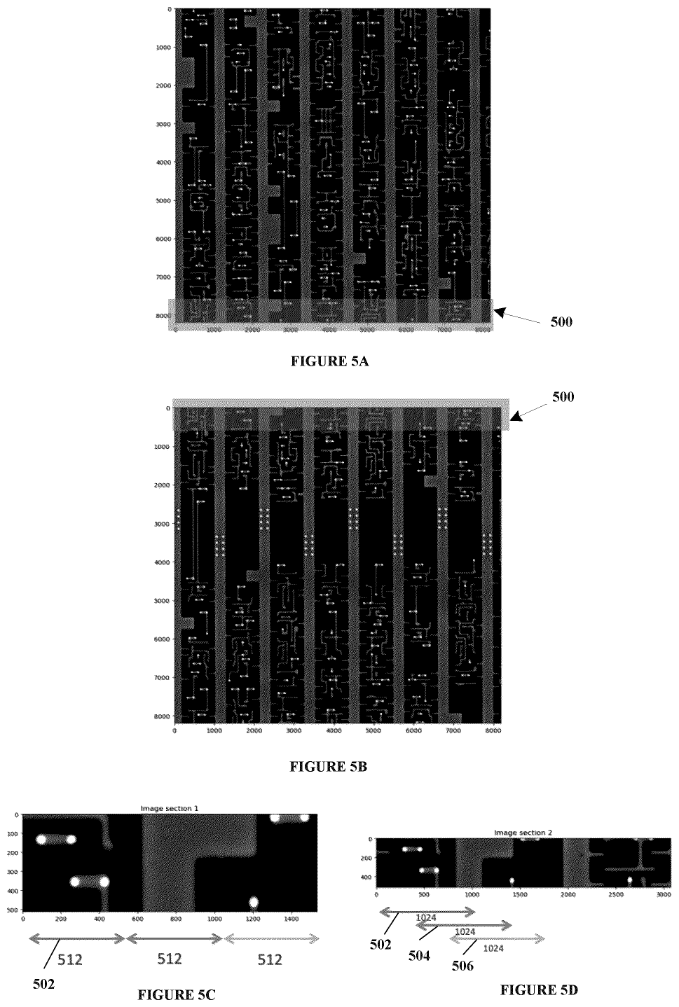

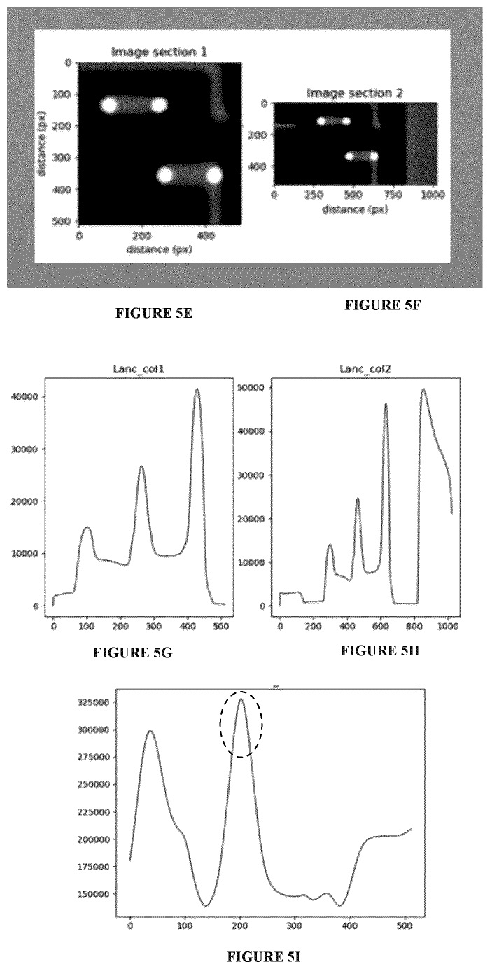

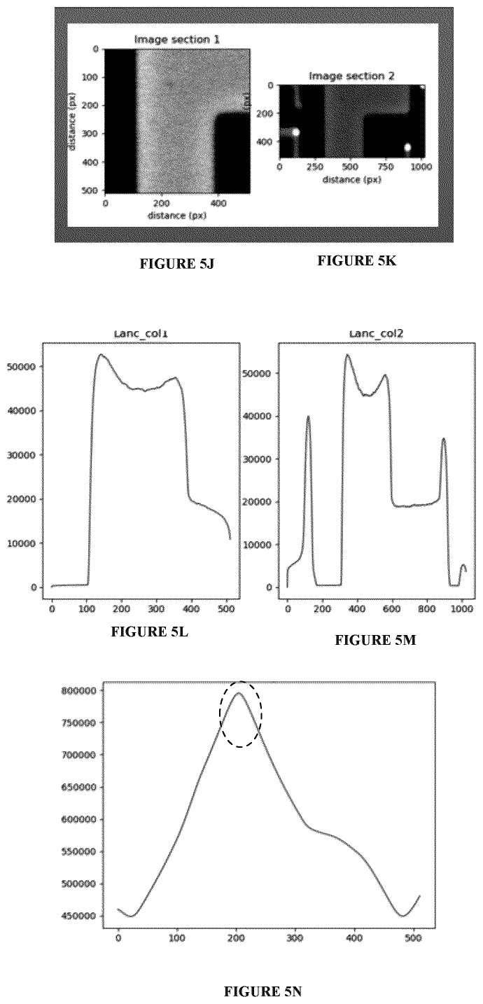

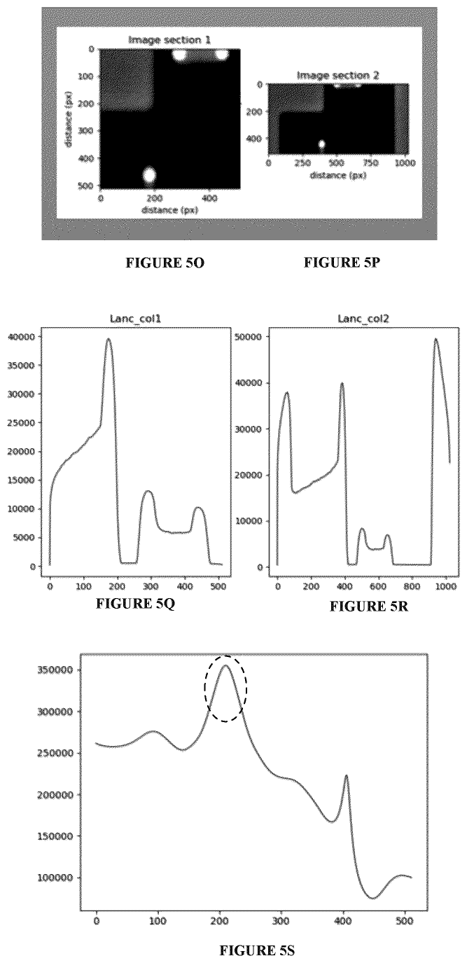

In FIGS. 5 to 7, three separate embodiments of method 10 in use, are illustrated, with various examples of each.

FIGS. 5A and 5B show larger images (with high resolution-8K) of again an IC, each with a shared horizontal overlap region 500 between them highlighted. FIGS. 5C and 5D show sub-images defined within the respective horizontal overlap regions 500 of FIGS. 5A and 5B. The arrows and associated values thereunder (representing pixel number) indicate portions of the sub-images to be individually analysed, as sub-sub-images of the larger images. More specifically, the arrow indicators in the sub-image of FIG. 5C show individual patches (each patch having a length of 512 pixels in this example) which will be searched for in the sub-image of FIG. 5D. The arrow indicators in the sub-image of FIG. 5D show corresponding individual search spaces which are searched (each search space having a length of 1024 pixels in this example), as discussed below.

FIGS. 5E and 5F show the respective sub-sub-images defined from the sub-images of FIGS. 5C and 5D, with FIG. 5E showing the defined patch to be searched for and FIG. 5F showing the defined search space within which FIG. 5E is to be searched. FIGS. 5G and 5H show the calculated image reductions of FIGS. 5E and 5F, respectively, specifically in each pixel column. Accordingly, peaks of the image reductions correspond to lighter regions of the sub-sub-images (or the patch and search space). FIG. 51 shows a cross-correlation function between the image reductions of FIGS. 5G and 5H, with a distinct peak being identifiable at the circle shown in broken lines. This distinct peak in turn, reflects the maximum correlation between the sub-sub-images of FIGS. 5E and 5F. Put differently, the maximum correlation reflects that indeed the patch of FIG. 5E can be located and/or aligned with the search space of FIG. 5F. This maximum correlation can inform an image transformation of, sub-sub-images of FIGS. 5E and 5F to one another or a global reference or otherwise, sub-images of FIGS. 5C and 5D to one another or a global reference, or yet otherwise, larger images of FIGS. 5A and 5B to one another or a global reference. In this specific embodiment, the image transformation between FIGS. 5E and 5F informs specifically the image transformation, specifically the alignment, of larger images FIGS. 5A and 5B to form a combined image (or otherwise an integrated image), which, once transformed or aligned, undergoes the same method with other edges to register the combined images with other larger images or combined images in a global reference frame. It is to be appreciated that the combined image obtained in some embodiments may contain more (useful) data as compared to the at least two images considered in isolation.

The example of FIG. 5 illustrates, for example, the customisability of method 10 in defining the sub-images or sub-sub-images from larger images (i.e. window selection) which allows for ongoing attempts to align images. For instance, if a self-correlation test failed on the pixel window (e.g. using window 502) of FIG. 5D, method 10 could then attempt another window (e.g. using window 504) of the same FIG. 5D to determine if an improved self-correlation is obtained. Similarly, if a poor cross-correlation using the 502 windows in two different images, such as FIGS. 5C and 5D, was obtained (e.g. alignment too far off for those windows to be properly overlapping), method 10 could then attempt the 502 window of FIG. 5C with the 504 or 506 windows of FIG. 5D. As such, defining sub-images and/or sub-sub-images may be particularly useful in cases where large numbers of images are to be registered and/or if differing quality images are to be registered. Defining sub-images and/or sub-sub-images may be performed with a sliding or shifting window, for example having a fixed pixel length but sliding or shifting in one direction to define new sub-images or sub-sub-images, typically having overlap portions with one or more previously defined sub-images or sub-sub-images.

FIGS. 5J and 5K reflect other exemplary sub-sub-images of differing dimensions defined from the sub-images of FIGS. 5C and 5D, with FIG. 5J showing the defined patch to be searched for and FIG. 5K showing the defined search space within which FIG. 5J is to be searched; FIGS. 5L and 5M show the image reductions calculated for the sub-sub-images of FIGS. 5J and 5K, wherein visual observation alone reveals similarity in the image reductions; and FIG. 5N shows the resultant cross-correlation of the image reductions of FIGS. 5L and 5M, reflecting the similarity profile of the sub-sub-images of FIGS. 5J and 5K with a first profile feature indicated in broken lines. This clear first profile feature reflects that indeed the patch of FIG. 5J can be located and/or aligned with the search space of FIG. 5K, which in turn informs image transformation and/or registering of the larger respective images.

FIGS. 5O and 5P reflect other exemplary sub-sub-images of differing dimensions defined from the sub-images of FIGS. 5C and 5D, with FIG. 5O showing the defined patch to be searched for and FIG. 5P showing the defined search space within which FIG. 5O is to be searched; FIGS. 5Q and 5R show the image reductions calculated for the sub-sub-images of FIGS. 5O and 5P, wherein visual observation alone is less revealing of similarity in image reductions; and FIG. 5S shows the resultant cross-correlation of the image reductions of FIGS. 5Q and 5R, reflecting the similarity profile of the sub-sub-images of FIGS. 5O and 5P with a first profile feature indicated in broken lines. This clear first profile feature reflects that indeed the patch of FIG. 5O can be located and/or aligned with the search space of FIG. 5P, which in turn informs image transformation and/or registering of the larger respective images.

FIGS. 6A and 6B show larger square images (8K) of again an IC, each with a shared horizontal overlap region therebetween highlighted. FIGS. 6C and 6D show rectangular sub-images defined within the respective horizontal overlap regions of FIGS. 6A and 6B. The arrows and associated values thereunder (representing pixel number) indicate portions of the sub-images that may be individually analysed, as sub-sub-images of the larger images. More specifically, the arrow indicators of FIG. 6C show individual patches (each patch having a length of 512 pixels in this example) which will be searched for in the sub-image of FIG. 6D. The arrow indicators of FIG. 6D show corresponding individual search spaces which will be searched (each search space having a length of 1024 pixels in this example), as discussed below.

FIGS. 6E and 6F show the respective sub-sub-images defined from the sub-images of FIGS. 6C and 6D, with square dimensions in FIG. 6E showing the defined patch from FIG. 6C to be searched for, and with rectangular dimensions in FIG. 6F showing the defined search space within FIG. 6D to be searched. FIGS. 6G and 6H show the calculated image reductions of FIGS. 6E and 6F, respectively, specifically in each pixel column. Accordingly, peaks of the image reductions correspond to lighter regions of the sub-sub-images. Visual observation alone is not very revealing of similarity. However, FIG. 61 shows a cross-correlation function between the image reductions of FIGS. 6G and 6H, with a distinct peak being identifiable at the circle shown in broken lines. This distinct peak in turn, reflects the maximum correlation between the sub-sub-images of FIGS. 6E and 6F. Put differently, the maximum correlation reflects that indeed the patch of FIG. 6E can be located and/or aligned with the search space of FIG. 6F. This maximum correlation can inform an image transformation of, sub-sub-images of FIGS. 6E and 6F to one another or a global reference or otherwise, sub-images of FIGS. 6C and 6D to one another or a global reference, or yet otherwise, larger images of FIGS. 6A and 6B to one another or a global reference. In this specific embodiment, the image transformation between FIGS. 6E and 6F informs specifically the image transformation, specifically alignment of larger images FIGS. 6A and 6B to form a combined image, which, once transformed or aligned, undergoes the same method with other edges to register the combined images with other larger images or combined images (e.g. a mosaic) in a global reference frame.

FIGS. 6J and 6K reflect other respective sub-sub images defined from the sub-images of FIGS. 6C and 6D, with FIG. 6J showing the defined patch from FIG. 6C to be searched for and FIG. 6K showing the defined search space within FIG. 6D which is to be searched; FIGS. 6L and 6M show the calculated image reductions of FIGS. 6J and 6K, wherein visual observation alone reveals that whilst the broad peaks may align, clarification is needed; and FIG. 6N shows the resultant cross-correlation function between the image reductions of FIGS. 6L and 6M, with the distinct peak providing the first profile feature shown. This first profile feature reflects that indeed the patch of FIG. 6J can be located and/or aligned with the search space of FIG. 6K, which in turn informs image transformation and/or registering of the larger respective images.

FIGS. 6O and 6P reflect other respective sub-sub images defined from the sub-images of FIGS. 6C and 6D, with FIG. 6O showing the defined patch from FIG. 6C to be searched for and FIG. 6P showing the defined search space within FIG. 6D which is to be searched; FIGS. 6Q and 6R show the calculated image reductions of FIGS. 6O and 6P, wherein visual observation alone reveals little similarity in image reductions; and FIG. 6S shows the resultant cross-correlation function between the image reductions of FIGS. 6Q and 6R, with the distinct peak providing the first profile feature shown. Once again, this first profile feature reflects that indeed the patch of FIG. 6O can be located and/or aligned with the search space of FIG. 6P, which in turn informs image transformation and/or registering of the larger respective images.

FIGS. 7A and 7B show larger square images (8K) of again an IC, each with a shared horizontal overlap region 700 between them highlighted. As shown, these images include at least partially periodic features or patterns. FIGS. 7C and 7D show rectangular sub-images of differing dimensions defined within the respective horizontal overlap regions 700 of FIGS. 7A and 7B. The arrows and associated values thereunder (representing pixel number) indicate portions of the sub-images that may be individually analysed, as sub-sub-images of the larger images. More specifically, the arrow indicators of FIG. 7C show individual patches (each patch having a length of 512 pixels in this example) which will be searched for in the sub-image of FIG. 7D. The arrow indicators of FIG. 7D show corresponding individual search spaces which will be searched (each search space having a length of 1024 pixels in this example), as discussed below.

FIGS. 7E and 7F show the respective sub-sub-images defined from the sub-images of FIGS. 7C and 7D, with square dimensions in FIG. 7E being the defined patch from FIG. 7C to be searched for and with rectangular dimensions in FIG. 7F being the defined search space within FIG. 7D which is to be searched. FIGS. 7G and 7H show the calculated image reductions of FIGS. 7E and 7F, respectively, specifically in each pixel column. Accordingly, peaks of the image reductions correspond to lighter regions of the sub-sub-images. FIG. 71 shows a cross-correlation function between the image reductions of FIGS. 7G and 7H, which illustrates how the similarity function may result when the images contain repetitive patterns like those shown in FIGS. 7E and 7F. In FIG. 71, a distinct peak is identifiable at the circle shown in broken lines. This distinct peak feature reflects that indeed the patch of FIG. 7E can be located and/or aligned with the search space of FIG. 7F. This distinct peak in turn, reflects the maximum correlation between the sub-sub-images of FIGS. 7E and 7F. This maximum correlation can inform an image transformation of the sub-sub-images of FIGS. 7E and 7F to one another or a global reference or otherwise, sub-images of FIGS. 7C and 7D to one another or a global reference, or yet otherwise, larger images of FIGS. 7A and 7B to one another or a global reference. In this specific embodiment, the image transformation between FIGS. 7E and 7F informs specifically the image transformation, specifically alignment of larger images FIGS. 7A and 7B to form a combined image, which, once transformed or aligned, undergoes the same method with other edges to register the combined images with other larger images or combined images in a global reference frame.

FIGS. 7J and 7K reflect other respective sub-sub images defined from the sub-images of FIGS. 7C and 7D, with FIG. 7J showing the defined patch from FIG. 7C to be searched for and FIG. 7K showing the defined search space within FIG. 7D which is to be searched; FIGS. 7L and 7M show the calculated image reductions of FIGS. 7J and 7K, wherein visual observation alone reveals little similarity in image reductions; and FIG. 7N shows the resultant cross-correlation function between the image reductions of FIGS. 7L and 7M, with the distinct peak providing the first profile feature shown. This first profile feature reflects that indeed the patch of FIG. 7J can be located and/or aligned with the search space of FIG. 7K, which in turn informs image transformation and/or registering of the larger respective images.

FIGS. 7O and 7P reflect other respective sub-sub images defined from the sub-images of FIGS. 7C and 7D, with FIG. 7O showing the defined patch from FIG. 7C to be searched for and FIG. 7P showing the defined search space within FIG. 7D which is to be searched; FIGS. 7Q and 7R show the calculated image reductions of FIGS. 70 and 7P, wherein visual observation alone indicates dissimilarity in image reductions; and FIG. 7S shows the resultant cross-correlation function between the image reductions of FIGS. 7Q and 7R, with the distinct peak providing the first profile feature shown. FIG. 7S illustrates that, in some embodiments, more than one distinct peak may be calculated from the image reductions. However, it is typically the first profile feature (or greatest peak) which informs the image transformation, as this reflects the maximum correlation. This first profile feature reflects that indeed the patch of FIG. 7O can be located and/or aligned with the search space of FIG. 7P, which in turn informs image transformation and/or registering of the larger respective images. The exemplary embodiment shown in FIGS. 7A to 7S further reflects, once again, that method 10 may be employed to register images containing at least partially periodic features or patterns in accordance with some embodiments of the disclosure.

In addition, the above exemplary embodiment shown in FIGS. 7A to 7S illustrates how the methods and systems disclosed herein can be utilised to identify promising sub-images or sub-sub-images (or defined boxes) with reliable features for the purposes of image registration. In particular, referring back to the sub-image in FIG. 7D, it is evident that the sub-sub-images of FIGS. 7F, 7K and 7P (all 1024 pixels) are overlapping portions of the sub-image of FIG. 7D, as shown. Using the methods and systems disclosed herein, similarity profiles are obtained (i.e. FIGS. 7I, 7N and 7S) based on the cross-correlations with the other corresponding sub-sub-images (FIGS. 7E, 7J and 7O). Therefore, the different similarity profiles represent, broadly, the different levels of similarity between the different sub-sub-image pairs. From these similarity profiles (FIGS. 7I, 7N and 7S), and in particular the profile features contained therein, the methods and systems disclosed herein may determine which sub-sub-images (and/or sub-images) provide reliable features which can be used to inform image transformation. In particular, sub-sub-images having reliable features upon cross-correlation may be utilised to register images in an overlap region between two or more larger images. Notably, this is in addition to the self-correlation step, wherein reliable sub-images or sub-sub-images are identified, as described above.

Further to the notion of recognising promising regions of different images to improve ultimate image registration, various embodiments additionally or alternatively relate to extending a search space for an image patch (e.g. an image, a sub-image, sub-sub-image, or the like) to be registered in an additional dimension. Such embodiments may be useful in cases where, for instance, the particular distribution or density of features in images to be registered, the signal-to-noise ratios within the images, or other challenges may lead to a misregistration.

For instance, FIG. 8A illustrates one example where an image patch 802 may be misaligned with a complementary image 804 upon registration when the search space is limited to one dimension. In FIG. 8A, the image patch 802 is shifted above the corresponding image 804 for clarity of viewing, while the plot 800 shows the vertical projection 806 of image patch 802 superimposed with the vertical projection 808 of the complementary image 804. In this case, the vertical projections 806 and 808 show promise for registration when the image patch 802 is translated to the interval 810 between x-axis values of approximately 20 to 170 in the plot 800. Indeed, translation of the image patch 802 to the interval 810 may correspond with an extremum in a correlation function between the vertical projections 804 and 808 within the 1D search space, resulting in registration, in accordance with embodiments described above.

However, visual inspection of the image patch 802 and the complementary image 804 shows that the two images are clearly not suitably registered at the interval 810, despite being characterised very similar vertical projections over this interval. In this case, the image patch 802 is characterised by high intensity features in its top right corner 812, possibly corresponding to vias or contact in the IC, and these intense features intersect a broad horizontal band of moderate intensity compared to background, which is one of two horizontal bands that span the entire patch 802 horizontally. This clearly does coincide with the interval 810 of the complementary image 804, which shows only a single horizontal band of moderate intensity spanning the interval 810, and an additional region of moderate intensity in the bottom right region 814. In this example, however, the vertical projections, taking into account only the sum of all columns of pixels, both exhibited high intensity values in their right-most regions over the interval 810. This contributed to a high correlation, despite that fact that the sources of intensity in the respective images originated from very different positions in the vertical direction.

FIG. 8B, on the other hand, illustrates how by translating the image patch 802 to the new interval 814, as well as shifting the image patch 802 vertically by a distance 816, the image patch 802 is clearly suitably for registration with the complementary image 804. In this case, in addition to providing continuous bands of moderate intensity, the high intensity features present in the top right region 812 of the patch 802 clearly match with a corresponding feature 818 in the complementary image. In this case, the corresponding feature 818 simply did not sufficiently contribute in vertical projection 808 to result in an extremum in correlation with the patch projection 806 in view of the vertical mismatch between images.

This example highlights how, if the estimate of the position of the image patch in one axis is inaccurate, the information in the image patch (e.g. sub-image, sub-sub-image, or the like) is different from the information in the search space window of a complementary image. With sufficient discrepancy, the difference in information may lead to poor or erroneous correlations, and ultimately hinder or preclude registration. At least in part to address this aspect, various embodiments of registration processes and systems herein described employing image projections along a first axis further comprise improving estimates of an image patch position along a second axis.

To this end, various embodiments relate to increasing the search space of a complementary image in an additional dimension, and calculating a projection along this additional axis for each of the images to be registered. Image patch projections along each axis may then be compared with those of the search space of the complementary image in this additional dimension (e.g. in 2D, rather than solely in 1D).

This aspect is illustratively shown in FIGS. 9A to 9H, in accordance with one exemplary embodiment. In this example, two images A and B have been acquired such that there is as overlap somewhere in the region 902 corresponding to both images. While the images A and B are schematically depicted in FIG. 9A as overlapping in the region 902, the precise area of overlap between the images is not yet known, as the images A and B still require registration. In order to more precisely or accurately register the two images A and B, a search space 904 is defined for a portion of image A in the region 902. Similarly, an image patch 906 is defined from image B. Zoomed in views of the exemplary search space 904 and image patch 906 are presented in FIGS. 9B and 9C, respectively.

In this exemplary embodiment, the image patch 906 is defined or extracted from image B such that that is corresponds to an area of image B that is estimated (before registration) to be approximately in the centre of the search space 904 corresponding to image A. This is schematically illustrated by the square 908 of FIG. 9B corresponding to the outline of the image patch 906, were it to be superimposed on the search space 904, based on an estimate of their respective positions before registration. In this example, and in accordance with some embodiments, the search space 902 and image patch 906 are of a square geometry, although it will be appreciated that other embodiments relate to different geometries, or combinations thereof. For example, a both the search space and the image patch may be rectangular, or one may be a square and the other a rectangle, or the like.

In accordance with some embodiments, the dimensions of the search space 904 and/or image patch 906 may be defined as a function of different parameters or estimates. For example, the search space 904 of FIG. 9B is defined with a height that is slightly larger than the estimated amount of overlap of the images A and B (e.g. the height of search space 904 is 105%, 120%, 200%, or the like of the estimated overlap between images A and B along that axis). Similarly, for rectangular search space geometries, the width of the search space 904 may in turn be a function of the height of the search space 904 (e.g. the search space width may be 1×, 2×, 3×, 5×, 10× the height of the search space, or the like). The image patch may similarly in turn be defined as a function of the search space geometry, in accordance with various embodiments. For example, the image patch 906 is defined such that each dimension (i.e. length and height) is one third of the corresponding dimension of the search space 904. However, it will be appreciated that various other embodiments relate to different relative sizes, dimensions, or geometries of a search space window and image patch to be registered therewith.

In the embodiment of FIGS. 9A to 9H, respective projections are generated for each axis of the image patch 906, as schematically shown in FIG. 9D. That is, all columns of pixels of the image patch 906 are summed to create a 1D ‘vertical’ projection 910, and all rows of the image patch 906 are summed to create a 1D ‘horizontal’ projection 912. The projections 910 and 912, in this embodiment, are characterised by dimensions of 1 pixel by the patch width (150 pixels) and the patch height (150 pixels), respectively.

Turning now to FIGS. 9E and 9G, projections may also be generated for the search space 904 in both axes or dimensions. However, in this embodiment, multiple projections are generated for each axis of the search space 904, rather than a single projection for each axis, as was performed for the image patch 906. For example, FIG. 9E schematically illustrates an exemplary process for generating seven vertical projections for the search space 904, wherein each vertical projection corresponds to a respective area of the search space 904. In this case, each projection area corresponds to the entire width of the search space 904, while columns of pixels are summed over respective ranges. Each range is respectively indicated schematically by vertical double-pointed arrows disposed between, and including, arrows 914 and 916 in FIG. 9E, which, overall, span the entire height of the search space 904.

In this example, each range corresponds to an interval spanning 150 pixels of each column, wherein the 150 pixels are summed to generate vertical projections for each interval. For example, a first projection is generated by summing the pixels 0 to 150 in the y-axis of the search space 904 for each column of pixels across the width of the search space 904. This range is schematically represented by the arrow 914. A second vertical projection is generated by summing the pixels between 50 and 200 in the y-axis of the search space 904, for each column across its width, as schematically illustrated by the double-arrow 918. This is repeated for each 150-pixel interval schematically represented by double-arrows, such that the entire height of the search space 904 is addressed in the generation of a vertical projection. In this case, the interval over which to sum pixels in a column is shifted by 50 pixels for each respective vertical projection, and each vertical projection spans 150 pixels of each column. However, it will be appreciated that other embodiments relate to different intervals of pixels over which to span (e.g. intervals of N pixels), and that intervals may be shifted by any number of pixels (e.g. M pixels), depending on, for instance, the application at hand, or the properties of the image patch 906 and/or the search space 904.

In FIG. 9D schematically illustrating the vertical projection 910 of the image patch 906, the vertical projection 910 was characterised by a 1D array 910, wherein each value corresponded to the summed intensity of the entire column of pixels defining the image patch 906. In FIG. 9E, on the other hand, the overall vertical projection 920 of the search space 906 is a 2D array of values. In this case, as there were seven projections calculated over seven different 150-pixel intervals spanning the height of the search space, the overall vertical projection 920 comprises a 2D array that is seven values in ‘height’, wherein each row of the overall vertical projection 920 corresponds to a particular one of the seven vertical projections previously calculated. That is, in the example of FIG. 9E, the uppermost row of the overall vertical projection 920 is the vertical projection calculated over the span 914 of the search space 904, while the second-uppermost row of the overall vertical projection 920 is the vertical projection calculated over the span 918, and so on. In this case, the overall vertical projection 920 thus a 2D array with a ‘height’ of 7 ‘pixels’, and a width of 450 pixels (i.e. the entire width of the search space 904).

A portion of the overall vertical projection 920 is presented as respective plots of intensity versus horizontal position in FIG. 9F. In this example, each plot of FIG. 9F corresponds to a particular row of the overall vertical projection 920. In this case, while the overall vertical projection 920 comprised seven ‘rows’ corresponding to respective vertical projections of respective areas of the search space 904, only the five central vertical projections are presented as respective plots in FIG. 9F for clarity (i.e. vertical projections from the areas corresponding to arrows 914 and 916 of the search space 904 are omitted from FIG. 9F).

The registration process then continues, in accordance with this particular embodiment, by comparing the vertical projection 910 of the image patch 906 with each of the respective vertical projections calculated for the search space 904 (e.g. the seven respective vertical projections calculated for each area of the search space 906 demarked by double-arrows in FIG. 9E, or each row of the overall vertical projection 920 of Figure E, or each vertical projection plot, select examples of which are shown in FIG. 9F). This comparison may be executed as described above (e.g. in accordance with a correlation process, or the like), to determine which area of the search space 904 provides the suitable comparison result (e.g. the highest degree of correlation) between the vertical projection 910 of the image patch 904 and the respective vertical projections of the search space 904. In this embodiment, the vertical projection 910, plotted as curve 922 in plot 924 in FIG. 9F, was compared with each of the search space vertical projection plots of FIG. 9F, as well as the omitted vertical projection plots corresponding to intervals 914 and 916. In this case, the best comparison (e.g. the highest correlation) was found with the search space projection 926 of plot 924 of FIG. 9F, which corresponds with the vertical projection calculated between pixels 150 and 300 in the y-axis of the search space 904. The optimal overlap was calculated in accordance with a transformation of the vertical projection 922 of the image patch 906 corresponding to a horizontal translation along the horizontal axis of the search space 904 to span, approximately, the pixels 145 to 295 (in the x-axis) of the search space 904 area vertically spanning pixels 150 to 300 (in the y-axis).

In this embodiment, the process described above with respect to the vertical projections in FIGS. 9E and 9F is also performed for horizontal projections, as schematically illustrated in FIGS. 9G and 9H. That is, horizontal projections are also calculated for the search space 904 over respective intervals (e.g. intervals 928 and 930, as well as other intervals schematically illustrated with double-arrows in FIG. 9G), which together span the entire width of the search space 904, and may define an overall 2D horizontal projection 932. The horizontal projection 912 of the image patch 904, shown as curve 934 in plot 936 of FIG. 9H, may also be compared with each respective horizontal projection of the search space 904. In this case, the central five horizontal projections of the search space 904 are presented in FIG. 9H, and the best comparison between the horizontal projection 934 of the image patch 906 and those of the search space 904 was found in the horizontal range of the search space 904 corresponding to pixels 150 to 300 (in the x-axis). The optimal transformation in this case corresponds to an image patch 904 vertical translation to overlap with, approximately, pixels 150 to 300 of the search space (in the y-axis).

This process may be repeated, in accordance with some embodiments, for each cell of a grid defined by the vertical and horizontal positions described above with respect to the search space 904 (i.e. in 2D over the search space 904). Further, it will be appreciated that, in accordance with various embodiments, any one of the transformations described above with respect to either FIGS. 9E and 9F or 9G and 9H may provide a greater degree of accuracy in an estimation for a transformation in one axis or the other. That is, a comparison (e.g. correlation) between respective vertical projections may often result in a computed horizontal translation which, when executed, produces registration of images that is better aligned in the x-axis than it is aligned in the y-axis, and vice versa. Stated differently, a vertical projections comparison returns an x-axis position that is closer to a ‘real’ position than a y-axis position (a ‘low-resolution’ position), and vice versa. By performing the calculations described above with respect to FIGS. 9A to 9H for both axes, and thus performing a 2D comparison, transformation results may be compared and/or evaluated to discard poor outcomes, thereby rejecting many poor transformation candidates (e.g. erroneous translations of images) and generally improving registration outcomes. Stated differently, by comparing ‘low-resolution’ results with ‘real’ results between transformations (i.e. results in both the x- and y-axis), various embodiments enable the filtering out of results that provide a low metric of comparison (e.g. a poor correlation).

Further, such respective transformations (e.g. translations in both the x- and y-axis) may inform an overall transformation to register images (e.g. a 2D transformation). Moreover, one of such transformations may inform the other to improve registration accuracy. For example, a first transformation (e.g. either a vertical transformation of the image patch 906 along the y-axis of the search space 906, as depicted in FIGS. 9E and 9F, or a horizontal transformation of the image patch 906 along the x-axis of the search space 906, as depicted in FIGS. 9G and 9H), may provide an improved estimate for a second transformation (e.g. the other of the two noted above). This may be beneficial if, for instance, a transformation in one of two axes is more challenging than the other, for any one or more of a variety of reasons. For instance, in the example of FIGS. 9A to 9H, features in the images A and B are generally aligned horizontally (i.e. along the x-axis). The horizontal projection 912 (i.e. curve 934) of the image patch 906 thus produces distinct topological features that are easily compared with corresponding features in the appropriate horizontal projection 938 of the search space 904. This comparison of horizontal projections to identify an extremum in a comparison metric (e.g. a maximum correlation) is thus performed more readily, or is less prone to error, than would be the case if the vertical projection 910 comparison was performed with an inaccurate estimate of the vertical alignment of the image patch 906 with respect to the search space 904. Accordingly, performance of a comparison in a particular axis before a comparison in another axis may be beneficial for reducing the time required to calculate an appropriate registration transformation, although it will be appreciated that simultaneous or alternating performance of various calculations with respect to different axes are similarly contemplated, in accordance with various embodiments.

For greater clarity, and in accordance with various embodiments, FIG. 9I schematically illustrates how the systems and processes described above with respect to FIGS. 9A to 9H may be applied to improve an estimation of the initial position for registration of two images. With reference again to the two images A and B sharing an overlapping region, the process described above with reference to FIGS. 9A to 9H may be iterated and/or repeated a designated number of times, over a number of regions of the images. In one embodiment, this comprises, for each iteration, shifting the position of the image patch 906 and the search space 904 by a designated distance (e.g. the width of the image patch 906, a function thereof, or as a function of a previously computed optimal translation). This is schematically illustrated in FIG. 9I by the shifting 940 of the image patch 906, and the corresponding shifting of the search window 904, which may, in some embodiments, be concentric therewith.

In one embodiment, the median position of the image patch 904 relative to the search space 906 with respect to one or both of the x- and y-axis may be used to calculate a subsequent image patch position estimation. This new estimation may, in accordance with one non-limiting embodiment, be calculated by: (1) calculating the median of a previous translation in both the x- and y-axes; (2) calculating the modulus of the medians in the x- and y-axes by a designated ‘STEP; (3) for each of the x- and y-axes, if the modulus is greater than designated value (e.g. STEP/2), subtracting step; and (4) providing a new estimation in both the x- and y-axes as the previous estimate, minus the result of the previous step (3).

While the previous process relates to one exemplary embodiment, various others may be similarly employed without departing from the general scope and nature of the disclosure. Regardless of the particular estimate calculation, such a process may be repeated until a designated threshold is reached. For example, one embodiment relates to repeating the process until a new estimation is equal to the previous estimation, or until a maximum number of iterations is reached. Once the process has stabilised and/or optimised, the relative position of each patch may be used to register the images, as described above.

It will be appreciated that various of the embodiments herein described provide several advantages over various other image registration techniques. For example, and without limitation, the 2D registration technique described above with respect to FIGS. 9A to 9I may provide information related to the entire search space in 2D, rather than two 1D ‘lines’ across the search space. In accordance with the estimation optimisation process described above this may correspond to a maximum error estimation of between-STEP/2 to +STEP/2. As a result, the likelihood of identifying an accurate transformation by way of a comparison is improved. To the same end, many poor correlations can be avoided through comparison of the results of x- and y-projection correlations. As a corollary, even with a poor initial estimation of an overlap position, comparisons are more likely to yield results that may be used to improve estimations, which can be iteratively improved through repeated calculation. Despite the 2D nature of such embodiments, such calculations using image projections remain computationally more efficient (i.e. faster) than conventional 2D image registration techniques, while maintaining the benefits of reduced noise (i.e. random noise of signals is reduced in accordance with the square root of the image patch size).

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. A method for registering at least two images, the at least two images each at least partially corresponding to a common region of interest, the method comprising:
for each of the at least two images, calculating respective image reductions along a first axis;
determining a similarity profile between said respective image reductions in accordance with a similarity function; and
identifying a first profile feature in said similarity profile to inform an image transformation for registering the at least two images.

2. The method of claim 1, further comprising:
for each of the at least two images, calculating respective second image reductions along a second axis;
determining a second similarity profile between said second image reductions in accordance with said similarity function; and
identifying a second profile feature in said second similarity profile to further inform said image transformation.

3. The method of either one of claim 1 or claim 2, wherein the at least two images are sub-images of respective larger images of the common region of interest.

4. The method of claim 3, wherein the method further comprises defining the at least two images from said respective larger images.

5. The method of any one of claims 1 to 4, wherein the at least two images are elements of a mosaic of at least partially overlapping images.

6. The method of any one of claims 1 to 5, wherein the at least two images are elements of respective adjacent edge portions of at least partially overlapping images of the common region of interest.

7. The method of any one of claims 1 to 6, wherein said respective image reductions comprise a plurality of numeric values.

8. The method of any one of claims 1 to 7, wherein said respective image reductions comprise a plurality of pixel intensity values.

9. The method of any one of claims 1 to 8, wherein said image reductions comprise one or more of a summation, a maximum intensity projection, an integration, an average, a weighted mean, a median, or a flattening of pixel intensities for a line of pixels in the at least two images respectively.

10. The method of any one of claims 1 to 9, wherein the at least two images comprise images of differing dimensions.

11. The method of any one of claims 1 to 10, wherein said similarity function comprises one or more of a correlation function, a convolution function, a sum-of-squared difference function, a Fourier transformation, or a bivariate correlation function.

12. The method of any one of claims 1 to 10, wherein said similarity function comprises a normalisation.

13. The method of any one of claims 1 to 11, wherein said similarity function comprises a self-correlation function.

14. The method of any one of claims 1 to 13, wherein said similarity function comprises a cross-correlation function.

15. The method of any one of claims 1 to 14, wherein said similarity function comprises one or more of a linear transformation, a non-linear transformation, a shift, a stretch, a skew, or a rotation, of one or more of the at least two images.

16. The method of any one of claims 1 to 15, wherein said determining said similarity profile comprises detecting any one or both of an image distortion or a scale difference between the at least two images.

17. The method of any one of claims 1 to 16, wherein said first profile feature comprises one or more extrema.

18. The method of any one of claims 1 to 17, further comprising:
determining a self-similarity profile for a first of said respective image reductions in accordance with a self-similarity function, and
identifying a self-similarity profile feature in said self-similarity profile corresponding to a designated degree of similarity.

19. The method of any one of claims 1 to 18, wherein said image transformation corresponds to one or more of a linear transformation, a non-linear transformation, a shift, a stretch, a skew, or a rotation, of one or more of the at least two images at least in part.

20. The method of any one of claims 1 to 19, wherein said image transformation comprises a transformation of at least one of the at least two images into another of the at least two images as a local image transformation.

21. The method of any one of claims 1 to 20, wherein said image transformation comprises a transformation of at least one of the at least two images into a global reference frame.

22. The method of any one of claims 1 to 21, further comprising applying said image transformation to at least one of the two or more images.

23. The method of any one of claims 1 to 22, wherein said image transformation comprises a pixel transformation of each pixel of one or more of the at least two images.

24. The method of any one of claims 1 to 23, wherein the at least two images comprise images of an integrated circuit layer.

25. The method of any one of claims 1 to 24, implemented by at least one processor in communication with a non-transitory computer readable medium, said non-transitory computer readable medium storing executable instructions, and an image storage database, said image storage database including at least the at least two images.

26. The method of any one of claims 1 to 25, operable as an intensity-based image registration method.

27. The method of any one of claims 1 to 26, operable in combination with a feature-based image registration method.

28. The method of any one of claims 1 to 27, wherein the at least two images comprise at least partially periodic features or patterns.

29. A digital image registration system operable to register at least two images, each corresponding at least in part to a common region of interest, the system comprising:
a memory on which the at least two images are stored in an image storage database; and
a digital data processor operatively connected to said memory to retrieve the at least two images from said image storage database, and operable to:
calculate respective image reductions for each of the at least two images along a first axis and optionally, along a second axis;
determine a similarity profile between said respective image reductions in accordance with a similarity function; and
identify a profile feature in said similarity profile to inform an image transformation for registering the at least two images.

30. The system of claim 29, wherein the at least two images are sub-images of respective larger images which, together with other larger images, comprise a mosaic of at least partially overlapping images.

31. The system of either one of claim 29 or claim 30, wherein the at least two images comprise respective adjacent edge portions of at least partially overlapping larger images.

32. The system of any one of claims 29 to 31, wherein said respective image reductions comprise intensity-based image reductions.

33. The system of any one of claims 29 to 32, wherein said respective image reductions comprise one or more of: a summation, a maximum intensity projection, an integration, an average, a weighted mean, a median, or a flattening, of pixel intensities for a line of pixels in the at least two images respectively.

34. The system of any one of claims 29 to 33, wherein said similarity function comprises one or more of: a correlation function, a convolution function, a sum-of-squared difference function, a Fourier transformation, or a bivariate correlation function.

35. The system of any one of claims 29 to 34, wherein said similarity function comprises any one or both of: a self-correlation function and a cross-correlation function.

36. The system of any one of claims 29 to 35, wherein said similarity function comprises one or more of: a linear transformation, a non-linear transformation, a shift, a stretch, a skew, or a rotation, of one or more of the at least two images.

37. The system of any one of claims 29 to 36, wherein said determining said similarity profile comprises detecting any one or both of: an image distortion, or a scale difference, between the at least two images.

38. The system of any one of claims 29 to 37, wherein said profile feature comprises one or more extrema.

39. The system of any one of claims 29 to 38, wherein said image transformation corresponds to one or more of: a linear transformation, a non-linear transformation, a shift, a stretch, a skew, or a rotation, of one or more of the at least two images, at least in part.

40. The system of any one of claims 29 to 39, wherein said image transformation comprises a transformation of at least one of the at least two images into another of the at least two images as a local image transformation.

41. The system of any one of claims 29 to 40, and wherein said image transformation comprises a transformation of at least one of the at least two images into a global reference frame.

42. The system of any one of claims 29 to 41, wherein said image transformation comprises a pixel transformation of each pixel of one or more of the at least two images.

43. The system of any one of claims 29 to 42, wherein said digital data processor is further operable to execute said image transformation and store a registered image on said image storage database.

44. The system of any one of claims 29 to 43, wherein the at least two images comprise images of an integrated circuit layer.

45. A non-transitory computer-readable medium storing executable instructions which, when executed by a digital data processor, are operable to:
retrieve at least two images, each corresponding at least in part to a common region of interest, from an image storage database;
calculate, via a digital data processor, respective image reductions for each of the at least two images along a first axis and optionally, along a second axis;
determine, via said digital data processor, a similarity profile between said respective image reductions in accordance with a similarity function; and
identify a profile feature in said similarity profile to inform an image transformation for registering the at least two images.

46. The non-transitory computer-readable medium of claim 45, wherein the at least two images are sub-images of respective at least partially overlapping larger images of the common region of interest.

47. The non-transitory computer-readable medium of either one of claim 45 or claim 46, wherein the at least two images are respective adjacent edge portions of at least partially overlapping larger images of the common region of interest.

48. The non-transitory computer-readable medium of any one of claims 45 to 47, wherein said respective image reductions comprise intensity-based reductions.

49. The non-transitory computer-readable medium of claim 48, wherein said intensity-based reductions comprise a plurality of pixel intensity values.

50. The non-transitory computer-readable medium of any one of claims 45 to 49, wherein said image reductions comprise one or more of a summation, a maximum intensity projection, an integration, an average, a weighted mean, a median, or a flattening, of pixel intensities for a line of pixels in the at least two images respectively.

51. The non-transitory computer-readable medium of any one of claims 45 to 50, wherein said similarity function comprises one or more of a correlation function, a convolution function, a sum-of-squared difference function, a Fourier transformation, or a bivariate correlation function.

52. The non-transitory computer-readable medium of any one of claims 45 to 51, wherein said similarity function comprises any one or both of: a self-correlation function and a cross-correlation function.

53. The non-transitory computer-readable medium of any one of claims 45 to 52, wherein said similarity function comprises one or more of a linear transformation, a non-linear transformation, a shift, a stretch, a skew, or a rotation, of one or more of the at least two images.

54. The non-transitory computer-readable medium of any one of claims 45 to 53, wherein said determine said similarity profile comprises detecting any one or both of an image distortion or a scale difference between the at least two images.

55. The non-transitory computer-readable medium of any one of claims 45 to 54, wherein said profile feature comprises one or more extrema.

56. The non-transitory computer-readable medium of any one of claims 45 to 55, wherein said image transformation corresponds to one or more of a linear transformation, a non-linear transformation, a shift, a stretch, a skew, or a rotation, of one or more of the at least two images at least in part.

57. The non-transitory computer-readable medium of any one of claims 45 to 56, wherein said image transformation comprises a transformation of at least one of the at least two images into another of the at least two images as a local image transformation.

58. The non-transitory computer-readable medium of any one of claims 45 to 57, wherein said image transformation comprises a transformation of at least one of the at least two images into a global reference frame.

59. The non-transitory computer-readable medium of any one of claims 45 to 58, wherein said image transformation comprises a pixel transformation of each pixel of one or more of the at least two images.

60. The non-transitory computer-readable medium of any one of claims 45 to 59, wherein said executable instructions further comprise instructions to execute said image transformation and store a registered image on said image storage database.
